(19) United States
(12) Patent Application Publication
(10) Pub. No.: US 2025/0103363 A1
(43) Pub. Date: Mar. 27, 2025

(54) PROCESSING UNIT FOR ENCRYPTED DATA

(71) Applicant: HECUSYS LLC, ATLANTA, GA (US)

(72) Inventor: PETER BREUER, MADRID (ES)

(73) Assignee: HECUSYS LLC, ATLANTA, GA (US)

(21) Appl. No.: 18/896,885

(22) Filed: Sep. 25, 2024

Related U.S. Application Data
(60) Provisional application No. 63/585,382, filed on Sep. 26, 2023.

(51) Int. Cl. G06F 9/455

(52) U.S. Cl. CPC G06F 9/45516

(57) ABSTRACT

A processor is provided. The processor includes a dynamic translation unit (DTU) configured to receive first binary words associated with a first machine code language instruction set from a memory unit of the processor and translate the first binary words to second binary words associated with a second machine code language.

### CROSS-REFERENCE TO RELATED APPLICATIONS

This application claims benefit of priority from U.S. Provisional Application No. 63/585,382 which is hereby incorporated by reference.

### BACKGROUND

The embodiments describe a processor that works encrypted, i.e., operates on encrypted data wherein the unencrypted data is never exposed. As far as the privileged observer (a program running in supervisor mode) or unprivileged observer (a program running in user mode) can tell, the user data in registers and memory of the processing device are in encrypted form. In the embodiments, the observer sees only encrypted values hiding uniformly and independently distributed user data with no statistical bias, that differs per each point in time and register and memory cell from that to be expected from the same program running unencrypted on a standard platform. The particular difference scheme under the encryption is determined randomly at compile time for each program and is not known to the processor as described in the embodiments below.

Data encryption is often used to protect sensitive information by transforming data using an encryption key to make the data unreadable without a corresponding decryption key. In a typical distributed computing arrangement, data stored on a first computer that it is desirable to process using the processing power of other computers is encrypted before it is transferred to the other computers. The other computers are arranged such that they decrypt the data and process the data to generate further data, before encrypting the further data and transferring the encrypted further data to the first computer. While such an arrangement allows data to be transferred between computers securely, the data is vulnerable when it is decrypted at the computers carrying out the distributed processing. It is within this context that the embodiments arise.

### BRIEF DESCRIPTION OF THE DRAWINGS

The described embodiments and the advantages thereof may best be understood by reference to the following description taken in conjunction with the accompanying drawings. These drawings in no way limit any changes in form and detail that may be made to the described embodiments by one skilled in the art without departing from the spirit and scope of the described embodiments.

FIG. 1 illustrates a Dynamic Translation Unit (DTU) positioned between the input to the pipeline's fetch stage and the (instruction path) memory management unit (iMMU) in the encrypted processor.

FIG. 2 illustrates further details of the dynamic translation unit in accordance with some embodiments.

FIG. 3 illustrates further details of a subunit of the DTU in accordance with some embodiments.

FIG. 4 illustrates a subunit sharing storage in accordance with some embodiments.

FIG. 5 provides a summary of the encrypted processor's RISCV instructions in accordance with some embodiments.

### DETAILED DESCRIPTION

Described herein, in various embodiments, is a processor that operates on encrypted data without decrypting the data, thereby not exposing unencrypted data during any of the processing or in any pipeline stage during the processing. The embodiments provide for mathematical security on (1) a special Complex Instruction Set Computer (CISC) machine code instruction set, and a ‘chaotic’ machine code compiler, as well as a platform of the processing device. It should be appreciated that Encryption serves to mix entropy generated by the compiler into the runtime traces. That entropy is sufficient that any indications that might be statistically observed and arise from the program doing something non-random are completely covered by the injected noise. The encrypted data observed at any point in the program is statistically uniformly distributed across the full spectrum of possible values in some embodiments. It is not the case, for example, that an encryption for 2 occurs more often than is to be expected from blind random chance among 2⁹⁶ possible values anywhere in the trace even if the program does nothing but print 2s. To take advantage of the variety of fast and open Reduced Instruction Set Computer (RISC) processor cores now available, in the processor described herein each CISC machine code instruction is translated on-the-fly to a small subset of standard RISC 32-bit machine code instructions plus custom additions. Translation is performed by a dynamic translation unit (DTU) on the instruction memory path for the fetch stage of the pipeline. An extra delay of one clock cycle is introduced on the memory path but is not be significant and should be reducible to zero if the fetch stage's pre-fetch algorithm is known in some embodiments. The embodiments described below provides the RISC machine code subset (including the RISC-V version) that supports the translations, the translation to RISC machine code from the CISC machine code, the CISC machine code itself, and the DTU. The CISC machine code provides security, but consists essentially of a subset of generic RISC modified to contain one 128b immediate constant in every arithmetic instruction. That instruction architecture ensures the required security properties are obtained. A few characteristics that a programmer/compiler implementer will appreciate about the encrypted processing apparatus and method disclosed herein include:
(a) the RISC-V instructions physically run in an environment consisting of 128-bit wide registers and memory locations. The register/memory locations contain either (i) a 128-bit encrypted value or (ii) an unencrypted value consisting of 96 high bits of statistically randomly distributed but deterministically generated padding and a 32-bit digital payload;
(b) despite (a), to a programmer/program the environment seems to be uniformly 32-bit, with 32-bit values contained in thirty-two 32-bit registers, because the real physical representation is not programmatically accessible; and
(c) there are actually 64 registers but the extra 32 are only available to the RISC-V instructions generated internally in the processor by translation via the DTU from the CISC source that the programmer conceived or compiled. The contents are not persistent from one translation sequence for a CISC instruction to the next. The extra registers exist in order to avoid disturbing the registers visible to the CISC programmer.
   Some in the subset of RISCV instructions internally available act arithmetically on a full 128 register bits but most act only on the lower 32 bits. Those that operate on 32-bit data will add an upper 96 bits of pseudo-random padding either automatically in parallel at the same time via a hash/padding unit next to the ALU, or via a custom 128-bit instruction run in sequence afterwards, depending on the configuration of the KPU.

The suffix ‘w’ is utilized for all those RISC-V instructions with a notionally 32-bit action but it should be appreciated that the most generic standard RISCV encoding available for use. That is, when there is a RISCV64 instruction (with a ‘w’) and a RISCV32 instruction (without a ‘w’) the RISCV32 encoding is used but the ‘w’ suffix is used to name it. It should be appreciated that this choice arises from some historical RISCV instruction set design inconsistency and current ambiguities. There are no base standard RISCV logical instructions (AND, OR, XOR) that act only on 32 bits in a 64-bit platform, whereas there are arithmetic instructions (ADDW, SUBW, etc) that do (the result is sign-extended to 64 bits). Instead the same RISCV instructions AND, OR, XOR with the same encodings work both on 32 and 64 bit platforms, but act on all bits of register data in both platforms. The encrypted processor environment disclosed herein is logically 32-bit but physically 128-bit and it should be appreciated that it makes no functional difference for a logically 32-bit instruction whether 32 or more than 32 bits are actually written by the instruction as the top 96 bits of the register will be overwritten with a hash. Thus, the embodiments enable the ability to indicate which instructions ‘see’ only the 32 bits and which ‘see’ all 128 bits and can manipulate those too. Since RISCV128 has not crystalized yet, it is not known what designation will be utilized by 32 bit instructions or which it will or will not have, nor what encodings it will use, and for the embodiments described herein it is decided that naming instructions that see 32 bits with a ‘w’ suffix but using the most general encoding available among compatible functionalities, so as not to force the issue.

Instruction sequences generated as translations of CISC source instructions as a practical matter need to access an extra upper 32 registers. To enable that with the RISCV standard instruction layout and its 5-bit register index fields, an instruction that effects register renaming may be used at the beginning of each translation sequence (and at the end, to restore the standard mapping). At most 8 or so registers in the upper 32 range of registers will be accessed in any one sequence. But for CISC translation sequences it is preferred to avoid instruction renaming because of the associated instruction and cycle count hit. The embodiments instead provide alternate versions of the standard RISCV instructions with opcodes situated in the CUSTOM portions of the standard opcode map. These access the top 32 registers instead of the bottom 32.

The embodiments described below are arranged in sections. Section 2 following on from here describes the standard RISCV instruction architecture and opcode map. Section 3 describes the encrypted processor internal register layout, names and conventional use. Section 4 details the subset of RISCV needed to translate the CISC instructions, the latter being described in Section 5. The translations from CISC to RISCV are described in Section 6 and the DTU hardware, which does the translation, is described in Section 7.

For reference, this section describes the standard RISCV instruction architecture. The standard RISCV opcode map specifies 7-bit opcodes of the form XXYYY11, as below in TABLE 1. The encrypted processor opcodes follow this map apart from in one instance, assigning each encrypted processor instruction that is obviously equivalent to a standard instruction (e.g. add two registers into a third) the standard coding. The remainder, apart from that instance, are assigned opcodes in the areas of the map labeled CUSTx/RSVDx.

TABLE 1

| | 000 | 001 | 010 | 011 | 100 | 101 | 110 | 111 |
|---|---|---|---|---|---|---|---|---|
| 00 | LOAD | LOADFP | CUST0 | MISCMEM | OPIMM | AUIPC | OPIMM32 | 48b |
| 01 | STORE | STOREFP | CUST1 | AMO | OP | LUI | OP32 | 64b |
| 10 | MADD | MSUB | NMSUB | NMADD | OPFP | RSVD1 | CUST2 | 48b |
| 11 | BRANCH | JALR | RSVD2 | JAL | SYSTEM | RSVD3 | CUST3 | >79b |

There is one instruction that falls outside the scheme of this table, and that is a ‘prefix’ instruction to load a 29-bit immediate. It has 0b01 instead of the table-standard 0b11 as the final two bits of the 7-bit opcode. That disambiguates it at decode stage from the standard instruction formats. Four prefix instructions in sequence will push 116 bits into the top of a 128-bit accumulator register and then a following standard RISCV instruction with a 12-bit immediate finishes the load. An alternative would be to load constant data into memory and read it to registers from there, but constant data is an ingredient in each of the CISC source instructions and it is preferable not to introduce memory-associated delays or remedies such as cache preloading.

The standard main RISCV instruction layouts are called R,I,B and S and their 7-bit opcodes all end in 11. Table 2 shows the physical layout in bigendian order (it will be appreciated that in other embodiments littleendian may be utilized for the physical layout). Bigendian, the most significant bit of each field and the whole instruction is at left, as it is when we write a number in decimal: 1234 has the 1 as the most significant digit and it is at left. Other than the OP7 opcode, there is a 3-bit FN3 function field, and for those instructions without an immediate constant occupying that space in the instruction, also a 7-bit FN7 function field:

TABLE 2

| | OP7 | | FN3 | | | FN7 |
|---|---|---|---|---|---|---|
| | 7 | 5 | 3 | 5 | 5 | 7 |
| std R | opcode₆₋₀[11] | r₄₋₀^{d} | f₂₋₀ | r₄₋₀^{s1} | r₄₋₀^{s2} | k₆₋₀ |
| std I | opcode₆₋₀[11] | r₄₋₀^{d} | f₂₋₀ | r₄₋₀^{s} | i₁₁₋₀ | |
| std B | opcode₆₋₀[11] | i₁₀i₃₋₀ | f₂₋₀ | r₄₋₀^{s1} | r₄₋₀^{s2} | i₉₋₄i₁₁ |
| std S | opcode₆₋₀[11] | i₄₋₀ | f₂₋₀ | r₄₋₀^{s1} | r₄₋₀^{s2} | i₁₁₋₅ |

It should be appreciated that decoding uniformly keys off the OP7 field first (least significant two bits examined first in there), then the FN3 and possibly FN7 fields. The R, I, B forms are basic, and the S form is a variant of B. There is also a J format, but it is not used by any instruction in the RISCV subset used by the encrypted processor.

To address 64 registers instead of 32, either (i) register renaming prior to a standard instruction is used, via a preceding write to a custom configuration/status register (CSR) where the map is held, via the RISC-V standard CSRRW instruction, or (ii) analogues of the standard instructions with opcodes OP7 in the CUSTOM areas of the standard table are used. The latter have the same format as the corresponding standard instruction but different opcode/function fields. Three bits of the FN3 and FN7 fields in the custom instructions are used to designate whether the corresponding register index references the lower or upper 32 of the available registers, following the pattern in Table 3:

TABLE 3

| | OP7 | | FN3 | | | FN7 | | | | |
|---|---|---|---|---|---|---|---|---|---|---|
| | 7 | 5 | 3 | 5 | 5 | 7 | | | | |
| CUST R | opcode₆₋₀[11] | r₄₋₀^{d} | f₂₋₀ | r₄₋₀^{s1} | r₄₋₀^{s2} | r₅^{d} | k₅ | r₅^{s1} | r₅^{s2} | k₂₋₀ |

| CUST I | opcode₆₋₀[11] | r₄₋₀^{d} | r₅^{d} | f₁ | r₅^{s} | r₄₋₀^{s} | i₁₁₋₀ | |
|---|---|---|---|---|---|---|---|---|
| CUST B | opcode₆₋₀[11] | i₁₀i₃₋₀ | r₅^{s1} | f₁ | r₅^{s2} | r₄₋₀^{s1} | r₄₋₀^{s2} | i₉₋₄i₁₁ |
| CUST S | opcode₆₋₀[11] | i₄₋₀ | r₅^{s1} | f₁ | r₅^{s2} | r₄₋₀^{s1} | r₄₋₀^{s2} | i₁₁₋₅ |

It should be appreciated that the r₅ bit set signifies the r₄₋₀ field references the upper 32 registers, unset signifies it references the lower 32. This system avoids ambiguities.

The following section describes the conventional layout and use (API) of the encrypted processor's register set. There are 32+32 126-bit wide registers. Many registers are paired for use with double length arithmetic instructions. Double length arithmetic instructions index only the first of a pair. The first contains the high bits and the second contains the low bits. Each will contain a 32-bit payload and a 96-bit hash, if in unencrypted form, else an encryption of that. Among the lower thirty-two registers, the t₂ₙ and t₂ₙ₊₁ registers are pairs, as are the c₂ₙ and c₂ₙ₊₁ registers, the a₂ₙ and a₂ₙ₊₁ registers, and the v₂ₙ and v₂ₙ₊₁ registers. In the upper thirty-two registers, registers t8, 19 are a pair, and so are registers maclo, machi and x0, x1. If a double length CISC arithmetic instruction indexes a register that is not first of a pair, it will be taken as paired with the ‘illr’ register 31 of the upper thirty-two during translation and will end up being treated as an illegal instruction further along the pipeline. For single length arithmetic instructions, the register pairings are not significant. Any of a pair can be used in any situation, singly or with the other of the pair, without restriction in some embodiments. The lower 32 registers are accessible directly from the CISC instruction interface and are named and used as follows in TABLE 4:

TABLE 4

| index | name | purpose |
|---|---|---|
| 0 | zer | zero reference (writable, rarely used) |
| 1 | sp | stack pointer |
| 2 | fp | frame pointer |
| 3 | a0 | function argument |
| 4 | a1 | function argument |
| 5 | a2 | function argument |
| 6 | a3 | function argument |
| 7 | a4 | function argument |
| 8 | a5 | function argument |
| 9 | ra | return address |
| 10 | c0 | caller clears |
| 11 | v0 | function return value |
| 12 | v1 | function return value |
| 13 | v2 | function return value |
| 14 | v3 | function return value |
| 15 | c1 | caller clears |
| 16 | t0 | temporary |
| 17 | c2 | caller clears |
| 18 | t1 | temporary |
| 19 | c3 | caller clears |
| 20 | t2 | temporary |
| 21 | c4 | caller clears |
| 22 | t3 | temporary |
| 23 | c5 | caller clears |
| 24 | t4 | temporary |
| 25 | c6 | caller clears |
| 26 | t5 | temporary |
| 27 | c7 | caller clears |
| 28 | t6 | temporary |
| 29 | c8 | caller clears |
| 30 | t7 | temporary |
| 31 | c9 | caller clears |

The zer register name is a holdover from classical RISC architectures that expect a non-writable register containing the zero value. For use in the encrypted processor the register must not be special and must be readable and writable like any other register. It will therefore be remapped to a different register than the conventional RISC zero register if an extant RISC-V core design is leveraged. The zer register here will generally be used for a base value in a short sequence of programmed calculations all using the same base value. An obfuscating compiler will take every opportunity to modify it and writing it with different values from time to time in generated code is a security positive. The ra register name is another holdover from classical RISC. It is not used for function call return addresses here (which are not accessible via the CISC interface). The holdover name is not meant to be limiting and the ra register can be used for any purpose. The temporary registers are intended for scratchpad calculations. The programmer should be aware that program-level macros may step on them. They are suitable for use within a single function body in code sequences that do not include another function call, and may be changed during a function call. They will not be changed by an interrupt as the encrypted processor copies registers internally to private storage on interrupt and restores them on return from the handler.

The caller clear registers are temporaries for which the caller reserves responsibility for save and restore on a function call. A callee should not attempt to save and restore these for its parent, but will do so for a function it calls in some embodiments. Other registers can be saved and restored by a callee as required in some embodiments. This convention shares out and reduces the burden of save and restore around a function call. All these registers will contain data at runtime that is either (encrypted) data or (encrypted) data addresses, never program addresses, encrypted or unencrypted, nor unencrypted data. The (RISC) instructions that generate, access and manipulate program addresses or have a cryptographic function within the encrypted processor are not available to the programmer.

The upper thirty-two registers are a mix of those for private use within instruction translation sequences in the pipeline, and mapped system configuration registers that have special functions. The private registers may possibly be cleared automatically between different instruction sequences, except for the Ink register, which contains a program return address for the next function call return. Certain of the nominally 4096 configuration/status registers (CSRs) available in a RISC-V architecture have been mapped into this set of 32 registers in order to avoid having to access them via the RISC-V CSRR* family of instructions, which are slow and allow for only 5 bits of immediate constant data in the instruction itself. Those are indicated by an entry in the ‘system’ column in Table 5 below.

TABLE 5

| index | name | purpose | system |
|---|---|---|---|
| 32 | xer | zero | — |
| 33 | t8 | temporary | — |
| 34 | t9 | temporary | — |
| 35 | maclo | accumulator low bits | — |
| 36 | machi | accumulator high bits | — |
| 37 | x0 | extra | — |
| 38 | x1 | extra | — |
| — | fpcsr | floating point control/status (unused) | 39 |
| 40 | unkn | unknown (unused) | — |
| — | esr | saved status | 41 |
| — | epcr | saved program counter | 42 |
| — | eear | saved arithmetic exception control (unused) | 43 |
| — | aecr | arithmetic exception control (unused) | 44 |
| — | aesr | arithmetic exception status (unused) | 45 |
| — | dtlbeir | data TLB entry invalidate (unused) | 46 |
| — | dtlbtr | data TLB translate (unused) | 47 |
| — | dtlbmr | data TLB match (unused) | 48 |
| — | sr | processor control/status | 49 |
| — | immucr | instruction MMU control | 50 |
| — | dmmucr | data MMU control | 51 |
| 52 | sfr | status flag | — |
| 53 | pc | program counter | — |
| 54 | lnk | link program address | — |
| 55 | pc1 | program counter plus one | — |
| 56 | cns | instruction constant | — |
| 57 | acc | instruction constant accumulator | — |
| 58 | acd | instruction constant accumulator | — |
| 59 | ace | instruction constant accumulator | — |
| — | rm | register renaming map | 60 |
| 61 | cA | caller clears | — |
| 63 | illr | illegal | — |

All 32 of this upper register set are inaccessible via the source CISC instructions, which can only reference the 32 in the lower register set. The t8, t9 pair are temporary registers, The cA register is a temporary register controlled by the caller rather than the present frame (i.e., it holds data of the caller to be accessed by a callee). The x0, x1 registers are an ‘eXtra’ pair for arbitrary use. The maclo, machi pair's names are holdovers from classical RISC that use them to hold an accumulating sum or low and high parts of a full-length multiplication and similar arithmetic operations. The unkn register is never referenced by an instruction in some embodiments. The sfr register contains the flag set by a conditional instruction and should be tested for a zero or nonzero value. The program counter register as read from an instruction shows the address of that instruction. A write is intercepted and sent to the fetch stage but one should preferably use the jump and branch instructions. On read from an instruction, the pc1 register shows the address of the next instruction beyond the current one and writing it does nothing in some embodiments. Both pc and pc1 registers count in (32-bit) instruction words, not bytes, as do all registers that contain instruction addresses. The Ink register contains the return address after a jump to a subroutine. The cns register is a dummy for internal use in the encrypted processor that contains an immediate CISC instruction constant if there was one in the CISC source instruction for the current translation sequence. The registers acc, acd and ace are loaded by the encrypted processor's custom prefix instruction that loads 128-bit CISC instruction immediate constants. Each loads 29 bits of the original 128-bit constant, doing shift and push into the accumulator registers each time in some embodiments. Subsequent RISC instructions may interrogate registers acc, acd, ace for the accumulated constants. The xer register on read provides a reference zero value, replacing the classical zer register in the lower thirty-two general purpose registers, which may be written to and changed. The xer register can be read from but not written to. The illr register cannot be read and an illegal instruction fault will be triggered if an instruction tries to. It is introduced as a placeholder by translation of some illegal CISC instruction configurations in some embodiments. It is also a safe place to discard data to when the available instructions force a write to some register of a datum that is not needed in the program.

Some special purpose registers/configuration status registers (CSRs) should in principle be accessed via the RISC-V CSRR* family of instructions and have been mapped into the upper 32 registers. This section describes their layout and use. It should be appreciated that that these register functions and layouts in the KPU are brought over from classical RISC implementations, and the RISCV layout of the corresponding CSR may differ in detail. Instructions that access RISCV CSRs directly should carry payloads modified to suit the platform. The fpcsr register (unused) controls/monitors the floating point unit. Different flags in it are set by distinct floating-point errors. Those would be security giveaways, so care is taken in the translations to RISC-V that this register and the others in this part of the register space should neither be directly accessible via CISC instructions, nor their state observable via indirect effects (such as causing an interrupt on divide by zero when in one state but not when in another). The esr register saves a copy of the processor status/control register on interrupt. It is not programmatically accessible from the CISC interface. Similarly, the epcr register saves a copy of the program counter on interrupt, and the eear register (unused) saves a copy of the arithmetic logic unit's exception status. The aecr register (unused) controls the arithmetic logic unit's delivery of exceptions. As designed, the encrypted processor's ALU never faults so there is no specific need. On division by zero it returns a false result and overflows and underflows are ignored. The aesr register (unused) in theory would record the exception and carry and overflow flags but those are not made available by the ALU in the encrypted processor. Carry and overflow can be predicted/diagnosed via the sign bits of operands and result. The dtlbeir, dtlbtr and dtlbmr registers (unused) could be used in future to access a custom hardware translation lookaside buffer (TLB) that does address translation from 128b to 32b on the fly. Currently access to the TLB is instead via the custom SETA, UNSA instructions. Those have the advantage of being synchronous: they wait the requisite amount of time for the TLB to finish each operation. Polling would have to be used if the dtlb* register interface were used instead. The dtlbtr register is where an address would be written for translation and the dtlbmr register is where the translation would be read from. The dtlbeir register is where an address would be written to invalidate the corresponding TLB entry. At present all entries in the TLB are reset at once rather than invalidated individually in other embodiments. The rm register contains the register name map. It is initialized with the lower 32 bits set to 0. That means that 5-bit register indices in standard instructions access the lower 32 registers. Setting the ith bit in the map to 1 means that register index i instead accesses the corresponding register in the upper 32 registers, which has index i+32. The upper 32 bits of the map are initialized to 1 and clearing some of them would have the confusing effect of making custom instructions that should access the upper 32 registers instead access the lower 32 registers which is not preferred. Writing the map may require an explicit pipeline flush (RISC ‘fence’ instruction or jump to the next instruction address) following immediately after to ensure the following instruction sees the changed map.

The sr register is the control register for the processor state. The SM bit controls the processor mode: user or administrator mode (ie. unprivileged and privileged, respectively: only two modes are needed for the KPU). There are 32 classically defined bits and the rest are used internally in the KPU. Currently 45 extra bits are in use. The legacy lower 32 bits are as follows in TABLE 6:

TABLE 6

| bit | name | purpose |
|---|---|---|
| 0 | SM | Supervisor mode |
| 1 | TEE | Tick timer exception enable |
| 2 | IEE | Interrupt exception enable |
| 3 | DCE | Data cache enable (unused) |
| 4 | ICE | Instruction cache enable (unused) |
| 5 | DME | Data MMU enable |
| 6 | IME | Instruction MMU enable |
| 7 | LEE | Little endian enable (unused) |
| 8 | CE | CID enable (unused) |
| 9 | F | Condition flag (unused) |
| 10 | CY | Carry flag (unused) |
| 11 | OV | Overflow flag (unused) |
| 12 | OVE | Overflow flag exception (unused) |
| 13 | DSX | Delay slot exception (unused) |
| 14 | EPH | Exception prefix high (unused) |
| 15 | FO | Fixed one (unused) |
| 16 | SUMRA | Supervisor SPR read access (unused) |
| 17-27 | RES | Reserved |
| 28-31 | CID | Context ID |

Most of those legacy bits are not in use for the encrypted processor or have been moved to another register in some embodiments. In particular, the condition flag is available as the sfr register. The supervisor mode and irq mask are the bits currently in use, as well as the CID in multiuser operation. The status register is automatically saved and restored on interrupt, so it does not need special care then. The immucr and dmmucr registers communicate with the classical instruction and data MMUs respectively. Writing those registers sets the position in memory and size of the page translation tables. There is no delay. The next instruction following behind will definitely see the altered tables with or without stalling. The data written to the dmmucr has the following format, bitwise:

| bit | name | purpose |
|---|---|---|
| 0 | DTF | DTLB flush |
| 1-9 | SIZ | log page table size in KB |
| 10-31 | PTBP | 22 bit page table base address in KB |

The page table can be placed anywhere in the first 4 GB of memory. Writing 0x1800 to the dmmucr sets fields 6.0.0, meaning no flush, table size is 2⁰ KB, ie. 1 KB, and the table starts 6 KB above zero, at address 0x1800 counted in bytes. Because the table size is set at 1 KB, the table ends at address 0x1c00, 7 KB above zero. Usually, a table will be some MB in size near top of memory which is similar for the immucr register. Page table entries can then be written directly to the tables in memory. The encrypted processor will snoop writes of page table entries to the tables and load its internal dTLB or iTLB caches from them. Instruction/data page address translation is not active in supervisor mode so writing dmmucr or immucr should leave supervisor mode running unaffected. The registers cannot be written from user mode in some embodiments. The data and instruction page table entries are 32 bits each. They are placed in memory in the page table area at an offset (counted in 32-bit words) corresponding to the page number of the logical page they define a mapping for. The bits define some flags for the page (read-only, executable, etc) and the physical device number for the target of the mapping and the physical page number on that device. Most of the flags are currently unused in the encrypted processor. They are as follows in TABLE 7 for data and instruction TLB entries respectively:

TABLE 7

| | data | TLB page table entry | | iinstruction | TLB page table entry |
|---|---|---|---|---|---|
| bit | name | purpose | bit | name | purpose |
| 0 | CC | cache coherency | 0 | CC | cache coherency |
| 1 | CI | cache inhibit | 1 | CI | cache inhibit |
| 2 | DID0 | device identifier 0 | 2 | DID0 | device identifier 0 |
| 3 | DID1 | device identifier 1 | 3 | DID1 | device identifier 1 |
| 4 | A | accessed | 4 | A | accessed |
| 5 | D | dirty | 5 | D | dirty |
| 6 | URE | user read enable | 6 | UXE | user execute enable |
| 7 | UWE | user write enable | 7 | RSV7 | reserved |
| 8 | SRE | supervisor read enable | 8 | SXE | supervisor execute enable |
| 9 | SWE | supervisor write enable | 9 | RSV9 | reserved |
| 10-31 | PPN | physical page number | 10-31 | PPN | physical page number |

There is room for four target device identifiers 0b00-11 in this format and the expectation is that the receiving device or controller does further mapping. The targets presently designate respectively the system memory, the peripheral controller, the 128-bit to 32-bit TLB complex, and the key manager.

Initial page table entries for the encrypted processor are loaded to a location high in the first page of memory as part of the BIOS image, and the startup code (in sector 0of the first page) sets the dmmucr and immucr to fit the initial page table around them, rather than vice versa. It will later be replaced during the operating system initialization sequence, but the location and entries are not in any way secret and do not need securing in some embodiments. User data is written to memory encrypted, and the table only controls to which part of memory that physically corresponds. The physical page numbers are 22 bits long, which with 8 KB pages allows 32 GB bits of address space to be mapped per target device. The page size is currently fixed at 8 KB for the encrypted processor. One page contains 2048 instruction words (32-bit) or 512 data words (128-bit) in some embodiments.

This section describes the subset of RISC-V machine code instructions used in the KPU 3.0 in the translations of CISC machine code instructions. This section is divided into parts, first the twenty or so custom instructions dealing with encryption/decryption, then the three instructions for memory access, the two custom register-register instructions, and the two conditional small jump instructions. Encryption/decryption in the encrypted processor is effected via custom instructions with opcodes in the CUST0 range of the standard opcode map, which is intended for additional instructions. The instructions are as follows:
(i) The decrX(r, s) instructions run AES decryption round X on the 128-bit value in register s using the current encryption key, writing the 128-bit result in register r. The encrX(r, s) instructions run encryption round X.
(ii) The getkd(r, s) instruction interrogates the crypto cache for the decryption of the 128-bit value in register s and puts the 128-bit result in register r if it is in cache and sets the special flag register sfr to 1. If it is not in cache, it returns 0 and sets sfr to 0. The getke(r, s) instruction does the same but for encryption instead of decryption.
(iii) The putkd(s, t) instruction expects an encrypted 128-bit value in register t and its decryption in register s, and loads the encryption cache with that information. An older entry (oldest in the same cache line) may be lost from cache. The putke(s, t) instruction does the same but with the encrypted value in s and its decryption in t. It is the same as putkd(t, s).
   These custom encrypted processor instructions use the RISCV R format described below. The extra top bit for a 6-bit register index occupies a position in the 7-bit function code field. A bit signifying a register index bit is shown as ‘r’ in the TABLE 8, a bit that is ignored is shown as ‘-’.

TABLE 8

| | | | 7 | 5 | 3 | 5 | 5 | 7 | | | | |
|---|---|---|---|---|---|---|---|---|---|---|---|---|
| instruction | opcode name | form | opcode val | r₄₋₀^{d} | f₂₋₀ | r₄₋₀^{s} | r₄₋₀^{t} | r₅^{d} | k₅ | r₅^{s} | r₅^{t} | k₂₋₀ |
| decr1 r^{d}, r^{s} | CUST0_DECR1 | R | 00_010_11 | rrrrr | 000 | rrrrr | — | r | 0 | r | 0 | 001 |
| decr2 r^{d}, r^{s} | CUST0_DECR2 | R | 00_010_11 | rrrrr | 000 | rrrrr | — | r | 0 | r | 0 | 010 |
| decr3 r^{d}, r^{s} | CUST0_DECR3 | R | 00_010_11 | rrrrr | 000 | rrrrr | — | r | 0 | r | 0 | 011 |
| decr4 r^{d}, r^{s} | CUST0_DECR4 | R | 00_010_11 | rrrrr | 000 | rrrrr | — | r | 0 | r | 0 | 100 |
| decr5 r^{d}, r^{s} | CUST0_DECR5 | R | 00_010_11 | rrrrr | 000 | rrrrr | — | r | 0 | r | 0 | 101 |
| decr6 r^{d}, r^{s} | CUST0_DECR6 | R | 00_010_11 | rrrrr | 000 | rrrrr | — | r | 0 | r | 0 | 110 |
| decr7 r^{d}, r^{s} | CUST0_DECR7 | R | 00_010_11 | rrrrr | 000 | rrrrr | — | r | 0 | r | 0 | 111 |
| decr8 r^{d}, r^{s} | CUST0_DECR8 | R | 00_010_11 | rrrrr | 000 | rrrrr | — | r | 1 | r | 0 | 000 |
| decr9 r^{d}, r^{s} | CUST0_DECR9 | R | 00_010_11 | rrrrr | 000 | rrrrr | — | r | 1 | r | 0 | 001 |
| decrA r^{d}, r^{s} | CUST0_DECRA | R | 00_010_11 | rrrrr | 000 | rrrrr | — | r | 1 | r | 0 | 010 |
| getkd r^{d}, r^{s} | CUST0_GETKD | R | 00_010_11 | rrrrr | 000 | rrrrr | — | r | 1 | r | 0 | 011 |
| putkd r^{s}, r^{t} | CUST0_PUTKD | R | 00_010_11 | — | 000 | rrrrr | rrrrr | 0 | 1 | r | r | 100 |
| encr1 r^{d}, r^{s} | CUST0_ENCR1 | R | 00_010_11 | rrrrr | 001 | rrrrr | — | r | 0 | r | 0 | 001 |
| encr2 r^{d}, r^{s} | CUST0_ENCR2 | R | 00_010_11 | rrrrr | 001 | rrrrr | — | r | 0 | r | 0 | 010 |
| encr3 r^{d}, r^{s} | CUST0_ENCR3 | R | 00_010_11 | rrrrr | 001 | rrrrr | — | r | 0 | r | 0 | 011 |
| encr4 r^{d}, r^{s} | CUST0_ENCR4 | R | 00_010_11 | rrrrr | 001 | rrrrr | — | r | 0 | r | 0 | 100 |
| encr5 r^{d}, r^{s} | CUST0_ENCR5 | R | 00_010_11 | rrrrr | 001 | rrrrr | — | r | 0 | r | 0 | 101 |
| encr6 r^{d}, r^{s} | CUST0_ENCR6 | R | 00_010_11 | rrrrr | 001 | rrrrr | — | r | 0 | r | 0 | 110 |
| encr7 r^{d}, r^{s} | CUST0_ENCR7 | R | 00_010_11 | rrrrr | 001 | rrrrr | — | r | 0 | r | 0 | 111 |
| encr8 r^{d}, r^{s} | CUST0_ENCR8 | R | 00_010_11 | rrrrr | 001 | rrrrr | — | r | 1 | r | 0 | 000 |
| encr9 r^{d}, r^{s} | CUST0_ENCR9 | R | 00_010_11 | rrrrr | 001 | rrrrr | — | r | 1 | r | 0 | 001 |
| encrA r^{d}, r^{s} | CUST0_ENCRA | R | 00_010_11 | rrrrr | 001 | rrrrr | — | r | 1 | r | 0 | 010 |
| getke r^{d}, r^{s} | CUST0_GETKE | R | 00_010_11 | rrrrr | 001 | rrrrr | — | r | 1 | r | 0 | 011 |
| putke r^{s}, r^{t} | CUST0_PUTKE | R | 00_010_11 | — | 001 | rrrrr | rrrrr | 0 | 1 | r | r | 100 |

| | | | | | | |
|---|---|---|---|---|---|---|
| std R | opcode val | r₄₋₀^{d} | f₂₋₀ | r₄₋₀^{s} | r₄₋₀^{t} | k₆₋₀ |

These instructions are used to decrypt the contents of register s into register r as follows:

| | |
|---|---|
| getkd r,s | # try cache for decryption first |
| cskip sfr,11 | # skip explicit decryption if was cached |
| decr1 r,s | # explicit decryption ... |
| decr2 r,r | |
| ... | |
| decrA r,r | |
| putkd r,s | # cache the new decryption |

There is also a custom I-format variant of the decr1 instruction that takes a 12-bit constant as depicted below:

| | | | 7 | 5 | 3 | | | 5 | 12 |
|---|---|---|---|---|---|---|---|---|---|
| instruction | opcode name | form | opcode val | r₄₋₀^{d} | r₅^{d} | f₁ | r₅^{s} | r₄₋₀^{s} | i₁₁₋₀ |
| decr1i r^{d}, r^{s}, i | CUST0_DECR1I | I | 00_010_11 | rrrrr | r | 1 | r | rrrrr | iiiii_iiiiiii |

| | | | | | |
|---|---|---|---|---|---|
| std I | opcode val | r₄₋₀^{d} | f₂₋₀ | r₄₋₀^{s} | i₁₁₋₀ |

This instruction is used to load a 128-bit immediate value for decryption in conjunction with four preceding prefix instructions. The latter push 29 bits at a time into the acc register as follows:

| | |
|---|---|
| prfx k₁₂₇₋₉₉ | # load 29 top bits of 128 |
| prfx k₉₈₋₇₀ | # load 29 more bits |
| prfx k₆₉₋₄₁ | # load 29 more bits |
| prfx k₄₀₋₁₂ | # load 29 more bits |
| decr1i r,acc,k₁₁₋₀ | # load 12 low bits and start decryption ... |

The prefix instructions leave a 12-bit space at the low end of the 128-bit accumulator register acc, and the decrli instruction fits its 12-bit immediate into that space, then runs decryption round 1. The decr1(r, s) instruction is equivalent to decr1i(r, s, 0). There is likewise a variant with a 12-bit immediate constant in KPU I-format, getkdi(r,s,i), of the getkd(r,s) instruction. This adds the 12-bit immediate constant i to register s before looking in the encryption cache, with return in r. The getkd(r,s) instruction is equivalent to getkdi(r,s,0).

| | | | 7 | 5 | 3 | | | 5 | 12 |
|---|---|---|---|---|---|---|---|---|---|
| instruction | opcode name | form | opcode val | r₄₋₀^{d} | r₅^{d} | f₁ | r₅^{s} | r₄₋₀^{s} | i₁₁₋₀ |
| getkdi r^{d}, r^{s}, i | CUST1_GETKDI | I | 01_010_11 | rrrrr | r | 1 | r | rrrrr | iiiii_iiiiiii |

| | | | | | |
|---|---|---|---|---|---|
| std I | opcode val | r₄₋₀^{d} | f₂₋₀ | r₄₋₀^{s} | i₁₁₋₀ |

There is also a variant with a 12-bit constant putkdi(r,s,i) of the putkdi(r,s) instruction to load the encryption cache, with putkd(r,s) equivalent to putkdi(r,s,0). This is in encrypted processor S format:

| | | | 7 | 5 | 3 | | | 5 | 5 | 7 |
|---|---|---|---|---|---|---|---|---|---|---|
| instruction | opcode name | form | opcode val | i₄₋₀ | r₅^{s1} | f₁ | r₅^{s2} | r₄₋₀^{s1} | r₄₋₀^{s2} | i₁₁₋₅ |
| putkdi r^{d}, r^{s}, i | CUST1_PUTKDI | S | 01_010_11 | iiiii | r | 0 | r | rrrrr | rrrrr | iiiiiii |

| | | | | | | |
|---|---|---|---|---|---|---|
| std S | opcode val | i₄₋₀ | f₂₋₀ | r₄₋₀^{s1} | r₄₋₀^{s2} | i₁₁₋₅ |

The aim of these latter two instructions together with decr1i is to support a sequence that decrypts a 128-bit immediate supplied via four prefix instructions but which also first checks and then possibly updates the encryption cache, as follows:

| | |
|---|---|
| prfx k127 - 99 | # load 29 top bits of 128 |
| prfx k98 - 70 | # load 29 more bits |
| prfx k69 - 41 | # load 29 more bits |
| prfx k40 - 12 | # load 29 more bits |

| | |
|---|---|
| getkdi r,acc,k11 - 0 | # load 12 low bits and check |
| cache for decryption cskip sfr,11 | # skip explicit |

decryption if decryption was cached decr1i r,acc,k11 - 0

# load 12 low bits and start explicit

decryption ... decr2 r,r
...

| | |
|---|---|
| decrA r,r | # end explicit decryption |

| | |
|---|---|
| putkdi r,acc,k11 - 0 | # store decryption pair in cache |

...

In supervisor mode, the encrX/decrX instructions act as though the encryption and decryption rounds were identity functions, i.e. no-ops. The getkd/getke instructions that interrogate the encryption cache just copy input to output without accessing the cache and set the flag register, as though cache lookup had been successful. The putkd/putke instructions do nothing.

The standard RISCV 32-bit load and store instructions add an immediate offset contained in the instruction to the address. In the setting of the encrypted processor, which is physically 128-bit, even adding a 32-bit zero might change the 96-bit upper padding part in a register, affecting the encrypted value. For better control, the encrypted processor has custom versions of load and store that do not add an immediate. These are get(r,s) and put(r,s), corresponding respectively to standard RISCV lq r,0[s] (load quad word) and sq 0[r],s (store quad word).

The get(r,s) instruction copies the 128-bit content of the memory at the 32-bit address con-tained in the low bits of register s to register r. The put(r,s) instruction copies the content of 128-bit register s to memory at the 32-bit address contained in the low bits of register r. Table 9 depicts the values

TABLE 9

| | | | 7 | 5 | 3 | 5 | 5 | 7 | | | | |
|---|---|---|---|---|---|---|---|---|---|---|---|---|
| instruction | opcode name | form | opcode val | r₄₋₀^{d} | f₂₋₀ | r₄₋₀^{s} | r₄₋₀^{t} | r₅^{d} | k₅ | r₅^{s} | r₅^{t} | k₂₋₀ |
| get r^{d}, r^{s} | CUST0_GET | R | 00_010_11 | rrrrr | 100 | rrrrr | — | r | 0 | r | 0 | 000 |
| put r^{s}, r^{t} | CUST0_PUT | R | 00_010_11 | — | 101 | rrrrr | rrrrr | 0 | 0 | r | r | 000 |

| | | | | | | |
|---|---|---|---|---|---|---|
| std R | opcode val | r₄₋₀^{d} | f₂₋₀ | r₄₋₀^{s} | r₄₋₀^{t} | k₆₋₀ |

To obtain a 32-bit address in order to store or retrieve data, the 128-bit encrypted address is submitted by the custom instruction seta(r) to the special Translation Lookaside Buffer (TLB) unit in the encrypted processor. The 128-bit encrypted address is placed in register r, and a 32-bit mapping for it is returned in the same register. The TLB may generate a memory fault, and then its function should be executed by a software handler instead. The TLB's internal database is mapped into general system memory and accessible from there. The information in it is not secret, may have been observed safely by administrator level programs as it was created, and may safely be manipulated by an administrator mode handler.

| | | | 7 | 5 | 3 | 5 | 5 | 7 | | | | |
|---|---|---|---|---|---|---|---|---|---|---|---|---|
| instruction | opcode name | form | opcode val | r₄₋₀^{d} | f₂₋₀ | r₄₋₀^{s} | r₄₋₀^{t} | r₅^{d} | k₅ | r₅^{s} | r₅^{t} | k₂₋₀ |
| seta r^{d} | CUST0_SETA | R | 00_010_11 | rrrrr | 101 | — | — | r | 0 | 0 | 0 | 100 |

| | | | | | | |
|---|---|---|---|---|---|---|
| std R | opcode val | r₄₋₀^{d} | f₂₋₀ | r₄₋₀^{s} | r₄₋₀^{t} | k₆₋₀ |

These instructions enable plaintext information consisting of 96 bits of padding and 32 bits of data held in register r to be stored encrypted in memory at a uniquely mapped replacement for an encrypted address, the 32-bit plaintext plus 96 bits padding decryption of which is held in register s, as follows:

| | |
|---|---|
| getke t1,r | # encrypt 32b data plus padding in r into register t1 |
| cskip sfr,11 | # . |
| encr1 t1,r | # . |
| encr2 t1,t1 | # . |
| ... | |
| encrA t1,t1 | # . |
| putkd t1,r | # . |
| getke t2,s | # encrypt 32b address plus padding in s into register t2 |
| cskip sfr,11 | # . |
| encr1 t2,s | # . |
| encr2 t2,t2 | # . |
| ... | |
| encrA t2,t2 | # . |
| putke t2,s | # . |
| seta t2 | # obtain 32b replacement for the 128b encrypted address |
| put t1,t2 | # write encrypted data at the 32b replacement address |

Storing not data but a program address at an encrypted address requires only the sequence from the second stanza on. A program address is never encrypted (its plaintext value would be known at least to within a certain range, creating a cryptographic vulnerability). Getting encrypted data back from memory takes the reverse sequence as depicted below:

| | |
|---|---|
| getke t2,s | # encrypt 32b address plus padding in s into register t2 |
| cskip sfr,11 | # . |
| encr1 t2,s | # . |
| encr2 t2,t2 | # . |
| ... | |
| encrA t2,t2 | # . |
| putke t2,s | # . |
| seta t2 | # obtain 32b replacement for the encrypted address |
| get t1,t2 | # read encrypted data from the 32b replacement address |
| getkd r,t1 | # decrypt data into register r |
| cskip sfr,11 | # . |
| decr1 r,t1 | # . |
| decr2 r,r | # . |
| ... | |
| decrA r,r | # . |
| putkd r,t1 | # . |

To retrieve a program address, which is held unencrypted in memory, the final stanza is elided.

The fence zer,zer,0b11111 1110000 instruction is used when a memory barrier is required. Implementations may differ as to the arguments required. The bits set in the 12-bit immediate denote different kinds of block.

| instruction | opcode name | form | opcode val | r₄₋₀^{d} | r₅^{d} | f₁ | r₅^{s} | r₄₋₀^{s} | i₁₁₋₇ | i₆₋₀ |
|---|---|---|---|---|---|---|---|---|---|---|
| fence | MISCMEM_FENCE | I | 00_011_11 | — | 0 | 0 | 1 | — | 11111 | 1110000 |

| | | | | | | |
|---|---|---|---|---|---|---|
| std I | opcode val | r₄₋₀^{d} | f₂₋₀ | r₄₋₀^{s} | i₁₁₋₇ | i₆₋₀ |

The instruction with no bits set in the 12-bit immediate can also be used as a no-op instruction, provided the RISC-V core supports it.

RISCV does not supply a conditional copy register instruction, but it is required in the KPU. The custom cmov(s,r1,r2) instruction moves data either from register r1 or r2 to register s according to whether the flag register sfr is nonzero or not. The unconditional version mov(s,r) is equivalent to cmov(s,r,r). It presents as a separate instruction because it has no runtime data dependence on the flag register sfr and hence an implementation may execute it faster.

| | | | 7 | 5 | 3 | 5 | 5 | 7 | | | | |
|---|---|---|---|---|---|---|---|---|---|---|---|---|
| instruction | opcode name | form | opcode val | r₄₋₀^{d} | f₂₋₀ | r₄₋₀^{s} | r₄₋₀^{t} | r₅^{d} | k₅ | r₅^{s} | r₅^{t} | k₂₋₀ |
| cmov r^{d}, r^{s}, r^{t} | CUST0_CMOV | R | 00_010_11 | rrrrr | 101 | rrrrr | rrrrr | r | 0 | r | r | 110 |
| mov r^{d}, r^{s} | CUST0_MOV | R | 00_010_11 | rrrrr | 101 | rrrrr | — | r | 0 | r | 0 | 111 |

| | | | | | | |
|---|---|---|---|---|---|---|
| std R | opcode val | r₄₋₀^{d} | f₂₋₀ | r₄₋₀^{s} | r₄₋₀^{t} | k₆₋₀ |

The cskip and cnskip custom instructions are for conditional small jumps forward within a sequence of RISC instructions derived from a single CISC instruction original. A standard RISC branch or jump instruction cannot be used because they are set up with target addresses created at compile time that take no account of how many RISC instructions may be inserted between them by the translation unit at runtime. They jump conditional on the named register (usually the sfr flag register) being set, for cskip, or unset for cnskip. They are S-format instructions depicted below:

| | | | 7 | 5 | 3 | | | 5 | 5 | 7 |
|---|---|---|---|---|---|---|---|---|---|---|
| instruction | opcode name | form | opcode val | i₄₋₀ | r₅^{s1} | f₁ | r₅^{s2} | r₄₋₀^{s1} | r₄₋₀^{s2} | i₁₁₋₅ |
| cskip r^{s1}, i | CUST2_CNSKIP | S | 10_110_11 | iiiii | r | 0 | 0 | rrrrr | — | iiiiiii |
| | CUST2_CSKIP | S | 10_110_11 | iiiii | r | 1 | 0 | rrrrr | — | iiiiiii |

| | | | | | | |
|---|---|---|---|---|---|---|
| std S | opcode val | i₄₋₀ | f₂₋₀ | r₄₋₀^{s1} | r₄₋₀^{s2} | i₁₁₋₅ |

The prefix instruction is non-standard and lies outside the standard instruction map and archi-tecture. That the last 2 bits of the 7 bit opcode are not 11 triggers the non-standard decode. The instruction loads 29 bits of data into the special accumulator register acc. It takes one of four 5-bit opcodes, according to whether the first two bits of the data are 00, 01, 10 or 11, and the remaining lower 27 bits of data fill out the rest of the instruction as depicted below.

| | | | 7 | 25 |
|---|---|---|---|---|
| instruction | opcode name | form | opcode val | i₂₄₋₀ |
| prfx 00 | XXXX_PRFX0 | X | 1i_i01_00 | i_iiii_iiii_iiii_iiii_iiii_iiii |
| prfx 01 | XXXX_PRFX1 | X | 1i_i10_00 | i_iiii_iiii_iiii_iiii_iiii_iiii |
| prfx 10 | XXXX_PRFX2 | X | 1i_i01_10 | i_iiii_iiii_iiii_iiii_iiii_iiii |
| prfx 11 | XXXX_PRFX3 | X | 11_i10_11 | i_iiii_iiii_iiii_iiii_iiii_iiii |

The prfx(i) instruction loads the 29 bits of immediate constant i into the upper portion of special register acc, leaving 12 zero bits at the bottom. What was in register acc—it started with the bottom 12 bits zero-is pushed up the register by the new insertion:

$$acc ← ( acc << 29 ) \vert ( i << 12 )$$

The 29 bits pushed up out of the top of register acc are pushed into the bottom of special register acd, and the 29 bits pushed up out of the top of register acd are pushed into the bottom of special register ace. This arrangement allows translation sequences to make use of multiple 128-bit constants supplied as immediates to a CISC instruction, as follows:

| | |
|---|---|
| prfx 0₁₁₋₀x₁₂₇₋₁₁₁ | # load upper part of constant x |
| prfx x₁₁₀₋₈₂ | # . |
| prfx x₈₁₋₅₃ | # . |
| prfx x₅₂₋₂₄ | # . |
| prfx x₂₃₋₀y₁₂₇₋₉₉ | # finish x, load upper part of y |
| prfx y₉₈₋₈₀ | # . |
| prfx y₇₉₋₄₁ | # . |
| prfx y₄₀₋₁₂ | # and start using immediate data: |
| addiw s, acc, y₁₁₋₀ | # complete loading y and add into s |
| addw r, r, acd | # add x to r |
| ... | |

The HGEN instruction generates a 96 bit hash from two 128 bit registers as input, placing it in the output register. The HPAD instruction mixes it into the input register and writes the combination into the output register as depicted below:

| | | | 7 | 5 | 3 | 5 | 5 | 7 | | | | |
|---|---|---|---|---|---|---|---|---|---|---|---|---|
| instruction | opcode name | form | opcode val | r₄₋₀^{d} | f₂₋₀ | r₄₋₀^{s1} | r₄₋₀^{s2} | r₅^{d} | f₅ | r₅^{s1} | r₅^{s2} | f₂₋₀ |
| hgen r^{d}, r^{s1}, r^{s2} | CUST0_HGEN | R | 00_010_11 | rrrrr | 001 | rrrrr | rrrrr | r | 1 | r | r | 101 |
| hpad r^{d}, r^{s1}, r^{s2} | CUST0_HPAD | R | 00_010_11 | rrrrr | 001 | rrrrr | rrrrr | r | 1 | r | r | 110 |

| | | | | | | |
|---|---|---|---|---|---|---|
| std R | opcode val | r₄₋₀^{d} | f₂₋₀ | r₄₋₀^{s1} | r₄₋₀^{s2} | f₆₋₀ |

In one embodiment there are eight variants of these instructions, each signalling whether a 5-bit register field is to be interpreted as referencing the upper or lower 32 registers respectively by whether the corresponding bit in the FN7 field is set or not. In an implementation that prefers register renaming in the instruction translation sequences, only the basic 0100111 and 0100101 instructions are required. The HPAD instruction is a convenience and could be replaced by RISCV128 instruction combinations. The action is to write the hash into the upper 96 bits of the target as depicted below:

$${r}_{d} ← {r}_{{s}_{1}} \& 0 xffffffff \vert {r}_{{s}_{2}} \& ∼ 0 xffffffff$$

The remainder of the subset of instructions used by the KPU for translation are standard RISCV. Additionally, custom versions of some of the basic RISCV instructions are implemented in preference to using register renaming to access the upper 32 of the 64 general purpose registers. These extra custom instructions are not essential and are aimed at lowering instruction and cycle count for translation sequences. If the upper 32 registers are implemented as CSRs, for example, then the RISCV CSRR* family of instructions can be used to swap out the contents of lower 32 registers into CSR storage for later restore, freeing the lower 32 up for use as scratchpad calculation space during a translation sequence. These instructions are intended to act arithmetically only on the lower 32 bits of the 128-bit registers while the top 96 bits are constructed in parallel and independently as a hash of the 128-bit inputs to the instruction and the instruction itself. Alternatively, the hash may be written in afterwards by a separate instruction, and the upper 96 bits may be written into or not written into, as convenient, by the instruction. There is choice as to whether to use, for example the generic RISCV32/64 ADD instruction, which works on the full register bit length on any platform, or the RISCV64 ADDW instruction, which produces only 32 bits and sign extends it to 64 bits as required. RISCV128 does not appear to be standardized yet, so it is not possible to be sure what is appropriate in a physically 128b environment. A ‘w’ placed on all the instruction names indicates that notionally 32b operation in a longer context is expected, but the generic instruction encoding is preferred where there is a choice between that and a ‘w’ instruction available in RISCV64.

No faults should ever be raised on divide-by-zero or overflow or underflow, ideally a random result should be silently returned, but any result at all is valid for security. It will be masked by noise from the 96 bits of hash. It is only important that an observer should not be able to tell that an interrupt might have occurred. In a possible implementation, interrupts should be masked via a call via a CSRRW instruction targeting the appropriate configuration status register (CSR) at the start of each sequence of RISC instructions that translate a single CISC instruction, and reinstated, if at all, by a restoring call at the end. The standard instructions are depicted in TABLE 10:

TABLE 10

| | | | 7 | 5 | 3 | 5 | 5 | 7 |
|---|---|---|---|---|---|---|---|---|
| instruction | opcode name | form | opcode val | r₄₋₀^{d} | f₂₋₀ | r₄₋₀^{s} | i₁₁₋₇ | i₆₋₀ |
| addiw r^{d}, r^{s}, i | OPIMM_ADDI | I | 00_100_11 | rrrrr | 000 | rrrrr | iiiii | iiiiiii |

| instruction | opcode name | form | opcode val | r₄₋₀^{d} | f₂₋₀ | r₄₋₀^{s} | r₄₋₀^{t} | k₆₋₀ |
|---|---|---|---|---|---|---|---|---|
| addw r^{d}, r^{s1}, r^{s2} | OP_ADD | R | 01_100_11 | rrrrr | 000 | rrrrr | rrrrr | 0000000 |
| mulw r^{d}, r^{s1}, r^{s2} | OP_MUL_MULDIV | R | 01_100_11 | rrrrr | 000 | rrrrr | rrrrr | 0000001 |
| subw r^{d}, r^{s1}, r^{s2} | OP_SUB | R | 01_100_11 | rrrrr | 000 | rrrrr | rrrrr | 0100000 |
| sllw r^{d}, r^{s1}, r^{s2} | OP_SLL | R | 01_100_11 | rrrrr | 001 | rrrrr | rrrrr | 0000000 |
| sltw r^{d}, r^{s1}, r^{s2} | OP_SLT | R | 01_100_11 | rrrrr | 010 | rrrrr | rrrrr | 0000000 |
| sltuw r^{d}, r^{s1}, r^{s2} | OP_SLTU | R | 01_100_11 | rrrrr | 011 | rrrrr | rrrrr | 0000000 |
| divw r^{d}, r^{s1}, r^{s2} | OP_DIV MULDIV | R | 01_100_11 | rrrrr | 100 | rrrrr | rrrrr | 0000001 |
| xorw r^{d}, r^{s1}, r^{s2} | OP_XOR | R | 01_100_11 | rrrrr | 100 | rrrrr | rrrrr | 0000000 |
| sraw r^{d}, r^{s1}, r^{s2} | OP_SRA | R | 01_100_11 | rrrrr | 101 | rrrrr | rrrrr | 0100000 |
| orw r^{d}, r^{s1}, r^{s2} | OP_OR | R | 01_100_11 | rrrrr | 110 | rrrrr | rrrrr | 0000000 |
| andw r^{d}, r^{s1}, r^{s2} | OP_AND | R | 01_100_11 | rrrrr | 111 | rrrrr | rrrrr | 0000000 |

Additionally, in some implementations a set of custom variants for some of those instructions in order to avoid using extra register renaming instructions in translation sequences. These have opcodes in the CUST regions of the standard opcode map. These custom instructions reference either the upper or lower 32 of 64 registers via their 5-bit register index field, depending as the corresponding bit in the function code is respectively set or unset as depicted in TABLE 11:

TABLE 11

| | | | 7 | 5 | 3 | | | 5 | 5 | 7 |
|---|---|---|---|---|---|---|---|---|---|---|
| instruction | opcode name | form | opcode val | r₄₋₀^{d} | r₅^{d} | f₁ | r₅^{s} | r₄₋₀^{s} | i₁₁₋₇ | i₆₋₀ |
| addiw r^{d}, r^{s}, i | CUST2_ADDI | I | 10_110_11 | rrrrr | r | 0 | r | rrrrr | iiiii | iiiiiii |

| | | | | | | |
|---|---|---|---|---|---|---|
| std I | opcode val | r₄₋₀^{d} | f₂₋₀ | r₄₋₀^{s} | i₁₁₋₇ | i₆₋₀ |

| instruction | opcode name | form | opcode val | r₄₋₀^{d} | f₂₋₀ | r₄₋₀^{s} | r₄₋₀^{t} | r₅^{d} | k₅ | r₅^{s}r₅^{t} | k₂₋₀ |
|---|---|---|---|---|---|---|---|---|---|---|---|
| addw r^{d}, r^{s1}, r^{s2} | CUST0_ADD | R | 00_010_11 | rrrrr | 000 | rrrrr | rrrrr | r | 0 | rr | 000 |
| subw r^{d}, r^{s1}, r^{s2} | CUST0_SUB | R | 00_010_11 | rrrrr | 000 | rrrrr | rrrrr | r | 1 | rr | 101 |
| sltw r^{d}, r^{s1}, r^{s2} | CUST0_SLT | R | 00_010_11 | rrrrr | 010 | rrrrr | rrrrr | r | 1 | rr | 110 |
| sltuw r^{d}, r^{s1}, r^{s2} | CUST0_SLTU | R | 00_010_11 | rrrrr | 011 | rrrrr | rrrrr | r | 1 | rr | 111 |

| | | | | | | |
|---|---|---|---|---|---|---|
| std R | opcode val | r₄₋₀^{d} | f₂₋₀ | r₄₋₀^{s} | r₄₋₀^{t} | k₆₋₀ |

As noted above, the ‘w’ suffix on all the arithmetic instruction names indicates these are arithmetically 32-bit operations, the 96-bit padding fill to 128 bits is generated non-arithmetically.

There are two standard B-format branch instructions as depicted below:

| | | | 7 | 5 | 3 | 5 | 5 | 7 |
|---|---|---|---|---|---|---|---|---|
| instruction | opcode name | form | opcode val | i₁₀i₃₋₀ | f₂₋₀ | r₄₋₀^{s2} | r₄₋₀^{s1} | i₉₋₄i₁₁ |
| beqw r^{s1}, r^{s2}, i | BRANCH_BEQ | B | 11_000_11 | iiiii | 000 | rrrrr | rrrrr | iiiiiii |
| bnew r^{s1}, r^{s2}, i | BRANCH_BNE | B | 11_000_11 | iiiii | 001 | rrrrr | rrrrr | iiiiiii |

The jump distance in the branch instruction is relative to the current processing core (PC) in the compiled program address space, which is not meaningful to the translation as the number of intermediate RISC instructions forward to the eventual target is not known and the current PC is in a virtual program address space that bears little relation to the originating instruction addresses in memory. The branch instruction has only one plausible use in translation sequences, and that is to abort the rest of the current sequence with beqw r,s,0 or bnew r,s,0. The zero jump is executed as a change of PC to the (real address of the) start of the next translation sequence. The translation unit has an input port for increments in the real address space to which this is directed, and a separate port for increments in the virtual address space of the translation sequences. The cskip/cnskip (see earlier section) instructions are used instead for jumps forward within a translation sequence in the virtual address space, and they can be used instead of a branch 0 instruction to jump to the end of the current sequence.

An absolute jump to a real program address needs the jalr instruction as depicted below:

| | | | 7 | 5 | 3 | 5 | 5 | 7 |
|---|---|---|---|---|---|---|---|---|
| instruction | opcode name | form | opcode val | r₄₋₀^{d} | f₂₋₀ | r₄₋₀^{s} | i₁₁₋₇ | i₆₋₀ |
| jalr r^{d}, r^{s}, i | JALR | I | 11_001_11 | rrrrr | 000 | rrrrr | iiiii | iiiiiii |

Additionally, in some emplementations there are custom versions of this instruction with opcodes in the CUST region of the standard map that access the upper 32 registers of the 64 general purposes available, in preference to register renaming:

| | | | 7 | 5 | 3 | | | 5 | 5 | 7 |
|---|---|---|---|---|---|---|---|---|---|---|
| instruction | opcode name | form | opcode val | r₄₋₀^{d} | r₅^{d} | f₁ | r₅^{s} | r₄₋₀^{s} | i₁₁₋₇ | i₆₋₀ |
| jalr r^{d}, r^{s}, i | CUST3_JALR | I | 11_110_11 | rrrrr | r | 0 | r | rrrrr | iiiii | iiiiiii |

| | | | | | | |
|---|---|---|---|---|---|---|
| std I | opcode val | r₄₋₀^{d} | f₂₋₀ | r₄₋₀^{s} | i₁₁₋₇ | i₆₋₀ |

The jump of jalr r,s,i is to the (real) address in register s plus i, and the (real) address a plus 1 is stored in register r. To branch to a relative real address, the programmer takes the current real address a and the increment i, and writes the target real address a+1+i as an offset from the zero register:

$$cnskip sfr , 1$$

$$jalr t , zer , a + 1 + i$$

If the flag register sfr is nonzero then execution drops through the cnskip into the jump. The target register t is a throwaway here. That sequence works if a+1+i does not overflow 12 bits, i.e., lies on page zero of program memory, but if it is larger then a prefix instruction must be used and the jump made relative to the prefix accumulator register:

$$cnskip ( sfr , 2 )$$

$${prfx [ a + 1 + i ]}_{31 - 12}$$

$$jalr t , acc , {[ a + 1 + i ]}_{11 - 0}$$

The prefix instruction leaves a 12-bit space at the low end of the accumulator register acc and the 12-bit immediate in the jump instruction fits into it to recreate the 32-bit target address. Up to a 41-bit address is theoretically attainable. With more prefixes 128-bit addresses are possible.

For return from interrupt the RISCV sret( ) instruction is used, with opcode SYSTEM SRET. The instruction runs in supervisor mode and changes mode to user. It reads the saved PC in the EPCR special register and jumps back to that program address, and it also reads the saved user status flags in the ESR register and restores them. A software interrupt is called with the RISCV ecall(r,s) instruction, containing opcode SYSTEM PRIV ECALL. The register use is implementation and platform dependent.

| instruction | opcode name | form | opcode val | r₄₋₀d | f₂₋₀ | r₄₋₀s | i₁₁₋₀ |
|---|---|---|---|---|---|---|---|
| ecall r^{d}, r^{s}, i | SYSTEM_PRIV_ECALL | I | 11_100_11 | rrrrr | 000 | rrrrr | 00000_000 0000 |
| sret | SYSTEM_SRET | I | 11_100_11 | — | 000 | — | 0 001 0_000 1000 |

The sret instruction runs in supervisor mode, and the ecall instruction runs both in user mode or supervisor mode.

Some system functions are implemented via reads from and writes to high register indices. Notionally those are registers, not just port numbers. The RISCV csrrw(s,r,h) and csrrc(r,s,h) in-structions respectively write data from/to register r to/from a system register/configuration status register (CSR). The CSR has a 12-bit index. These are I-format instructions. RISCV specifies that CSSRW may swap out the CSR content to a second register indexed in the instruction, but that option is not presently used in the KPU translations and the field is set at 0. A similar 5-bit field in the CSRRC instruction specifies a register containing a bitmask for bits to clear in the CSR being read, but that is not presently used in the encrypted processor and the field is set at 0 here. The CSSRWI instruction is a variant that interprets the source register index field as a 5-bit immediate constant, zero-filled for the target CSR.

| | | | 7 | 5 | 3 | 5 | 12 |
|---|---|---|---|---|---|---|---|
| instruction | opcode name | form | opcode val | — | f₂₋₀ | r₄₋₀^{s} | s₁₁₋₀^{d} |
| csrrw O, r^{s}, s^{d} | SYSTEM_CSRRW | I | 11_100_11 | 00000 | 001 | rrrrr | ssssssssssss |
| csrrwi O, k, s^{d} | SYSTEM_CSRRWI | I | 11_100_11 | 00000 | 101 | kkkkk | ssssssssssss |

| instruction | opcode name | form | opcode val | r₄₋₀^{d} | f₂₋₀ | — | s₁₁₋₀^{s} |
|---|---|---|---|---|---|---|---|
| csrrc r^{d}, O, s^{s} | SYSTEM_CSRRC | I | 11_100_11 | rrrrr | 011 | 00000 | ssssssssssss |

These instructions work in supervisor mode. One use is with the immucr and dmmucr system register targets to create entries in the page address map for user mode, respectively in the instruction and data page address translation buffer units, preparatory to a switch to user mode (thread-specific mapping in multitasking operating systems allows different user mode process threads to avoid stepping on each others physical storage areas).

In order to avoid the extra instruction and cycle count of instruction renaming, some implementations provide custom versions of these instructions that reference the upper 32 general purpose registers instead of the lower 32. Their opcodes lie in the CUST range of the RISCV standard opcode map.

| | | | 7 | 5 | 3 | 5 | 12 |
|---|---|---|---|---|---|---|---|
| instruction | opcode name | form | opcode val | — | f₂₋₀ | r₄₋₀^{s} | s₁₁₋₀^{d} |
| csrrw O, r^{s}, s^{d} | CUST2_CSRRW | I | 10_110_11 | 00000 | 000 | rrrrr | ssssssssssss |

| instruction | opcode name | form | opcode val | r₄₋₀^{d} | f₂₋₀ | — | s₁₁₋₀^{d} |
|---|---|---|---|---|---|---|---|
| csrrc r^{d}, O, s^{s} | CUST3_CSRRC | I | 11_110_11 | rrrrr | 011 | 00000 | ssssssssssss |

The CISC machine code language that user-level programmers use to access the encrypted processor is a small generic RISC subset with 128-bit immediate constants. A CISC instruction can be very long, as much as 16 or more (32-bit) words, but it is consistently organized as follows. A CISC instruction consists of a number, possibly zero, of prefix words supplying immediate constants to the instruction, followed by a final word that specifies the operation and source and target registers for the instruction. The register fields in the final word of a CISC instruction are 5 bits wide, referencing 32 user-programmable general purpose registers. Each appears 32 bits wide to the programmer but physically in the encrypted processor, the 32-bit data is encoded as a 128-bit encryption. The encryption covers 32-bit data plus with 96 bits of statistically randomly distributed padding.

CISC arithmetic instructions always include one or more 128-bit encrypted immediate con-stants. The C.add r,s,t,k′ instruction, for example, incorporates exactly one: k′. The following is the breakdown of the instruction into five individual 32-bit words, in increasing byte address order from byte a+0 to a+19 inclusive. The address of the whole instruction is a and it is 20 bytes long. The prefix with the most significant bits comes first:

| | |
|---|---|
| a+0: | C.prf k′₁₂₇₋₉₉ |
| a+4: | C.prf k′₉₈₋₇₀ |
| a+8: | C.prf k′₆₉₋₄₁ |
| a+12: | C.prf k′₄₀₋₁₂ |
| a+16: | C.add r, s, t, k′₁₁₋₀ |

The 128-bit immediate constant k′ carried by the prefixes is the 128-bit encryption of a 32-bit constant k. This instruction/instruction sequence performs the operation

$$r ← s + t + k$$

encoded as encrypted values in registers r, s and t.

The final C.add r^{d}, r^{s1}, r^{s2}, k′ word's 32 bits are organized as follows:

| | 5 | 5 | 5 | 5 | 12 |
|---|---|---|---|---|---|
| instruction | C.ADD | r^{d} | r^{s}^{₁} | r^{s}^{₂} | k′ |
| C.add r^{d}, r^{s1}, r^{s2}, k | 00001 | rrrrr | rrrrr | rrrrr | kkkk_kkkk_kkkk |

The arithmetic instructions that take two arguments and produce a result all have this same architecture. That is a 5-bit major opcode, three 5-bit register fields, then a 12-bit immediate (that will be the final 12 bits of a 128-bit immediate the rest of which has been supplied by preceding prefix words). This is the list of the opcodes:

| opcode name | C. ADD | C. SUB | C. MUL | C. DIV | C. SRA | C. SLL | C. XOR | C. AND | C. OR |
|---|---|---|---|---|---|---|---|---|---|
| opcode val | 00001 | 00010 | 00011 | 00100 | 00101 | 11000 | 10101 | 10110 | 10111 |

Prefix words each have the 3-bit opcode 111, followed by 29 bits of data as depicted below.

| | 3 | 29 |
|---|---|---|
| instruction | C.PRF | k |
| C.prf k | 111 | k_kkkk_kkkk_kkkk_kkkk_kkkk_kkkk_kkkk |

No other opcode begins 111.

Add and subtract are the only arithmetic CISC instructions that take just one immediate constant. The rest have two or three, requiring respectively 5+4 or 5+5+4 prefix words each. The functionality of the CISC arithmetic instructions always has the same pattern. For example, for multiplication C.mul r s t a′b′c′, where the 128-bit immediate constants a′, b′, c′encrypt the 32-bit values a, b, c respectively, the functionality is as follows:

$$r ← ( s + b ) * ( t + c ) - a$$

One immediate is added to each of the arguments and one is subtracted from the result. There is the full complement of CISC comparator instructions, less than, greater than, less than or equal to, greater than or equal to, in signed and unsigned versions, as well as equals and not equals. Each sets a flag in the status register on success and unsets it on failure. Signed comparison instructions have one immediate constant, unsigned comparisons have two. The functionality of the less-than comparison is

$$flag ← r < s + k$$

while the functionality of the unsigned less-than comparison is

$$flag ← r + a < s + b$$

The final word of CISC comparator instructions has two (5-bit) register index fields and a 10-bit opcode. The layout for C.sfltu (unsigned less than) is shown below. The word also contains the 12-bit rump of one of the two immediate constants, the rest being supplied in the prefix words as depicted below:

| | 10 | 5 | 5 | 12 |
|---|---|---|---|---|
| instruction | C.SFLTU | r^{s}_{¹} | r^{s}_{²} | k |
| C.sfltu(r^{s1}, r^{s2}, k) | 00111_00110 | rrrrr | rrrrr | kkkk_kkkk_kkkk |

The list of opcodes of the comparator instructions is as follows. Each is 10 bits long and begins with the 5-bit code 00111:

| | C. SFLT | C. SFGT | C. SFLE | C. SFGE | C. SFEQ | C. SFNE |
|---|---|---|---|---|---|---|
| 00111 | 00000 | 00001 | 00010 | 00011 | 00100 | 00101 |

| | C. SFLTU | C. SFGTU | C. SFLEU | C. SFGEU |
|---|---|---|---|---|
| 00111 | 00110 | 00111 | 01000 | 01001 |

There are three single-word branch instructions, two conditional and one unconditional. The C.bf k and C.bnf k instructions respectively jump ahead by k when the flag bit in the status register is set and when it is not set. The C.b k instruction jumps unconditionally. The opcode is 12 bits long, beginning with the five bits 01101, and the address increment k is 20 bits long as depicted below.

| | 5 | 7 | 20 |
|---|---|---|---|
| C.bf k | 01101 | 0000000 | kkkk_kkkk_kkkk_kkkk_kkkk |
| C.bnf k | 01101 | 1000001 | kkkk_kkkk_kkkk_kkkk_kkkk |
| C.b k | 01101 | 1100001 | kkkk_kkkk_kkkk_kkkk_kkkk |

There are two single-word jump instructions that jump to a fixed target address k, C.jal k and C.j k, for 26-bit addresses k, with a 6-bit opcode, as well as a return from subroutine instruction:

| | 5 | 1 | 26 |
|---|---|---|---|
| C.jal k | 10100 | 0 | kk_kkkk_kkkk_kkkk_kkkk_kkkk_kkkk |
| C.j k | 10100 | 1 | kk_kkkk_kkkk_kkkk_kkkk_kkkk_kkkk |
| C.ret | 01101 | 0 | 00_0000_0000_0000_0000_0000_0000 |

The instruction C.jal k is used to call a subroutine at address k. That puts the next instruction address as the return address in the (hidden) return address register lnk. A C.ret instruction at the end of the subroutine restores the program counter from that register. The nth software interrupt handler is called with the single-word C.sys n instruction, which will jump to the nth in a fixed vector of handlers on memory page zero and change to supervisor mode. Return from the handler to user mode is via the single-word C.rfe instruction as deicted below:

| | 5 | 11 | 16 |
|---|---|---|---|
| C.sys n | 01101 | 110_0010_0000 | nnnn_nnnn_nnnn_nnnn |
| C.rfe | 01101 | 110_0011_0000 | 0000_0000_0000_0000 |

Memory access is via two multi-word instructions. The C.lw r,k′[s] instruction writes to register r from the address in register s offset by k, and the C.sw [k′]r,s instruction reads from register s to the address in register r offset by k. Prefix words supply all but 12 bits of the 128-bit encrypted offset k′, the final 12 bits are part of the final word which has the following form:

| | 5 | 5 | 5 | 5 | 12 |
|---|---|---|---|---|---|
| C.lw r^{d}, k′₁₁₋₀[r^{s}] | 10001 | rrrrr | rrrrr | 00000 | kkkk_kkkk_{—} |
| | | | | | kkkk |
| C.sw k′₁₁₋₀[r^{s1}], r^{s2} | 10000 | rrrrr | rrrrr | 00000 | kkkk_kkkk_{—} |
| | | | | | kkkk |

The memory barrier is the single-word instruction C.msync( ), which forces writes through to memory (i.e., holds off further writes until existing writes have finished). The pipeline barrier is the single-word instruction C.psync( ), which asserts data dependencies such that instructions behind cannot progress until it exits.

| | 5 | 11 | 16 |
|---|---|---|---|
| C.msync | 01101 | 110_0100_0000 | 0000_0000_0000_0000 |
| C.psync | 01101 | 110_0101_0000 | 0000_0000_0000_0000 |

There is a single-word conditional move instruction C.cmov r,s,t that if the flag bit in the status register is set copies content of register s to r, while if it is unset then it copies the content of register t to r. Also a single-word instruction C.xchg r,s that swaps the contents of registers r and s, and an instruction C.nop k that does nothing at all.

| | 5 | 11 | 1 | 5 | 5 | 5 |
|---|---|---|---|---|---|---|
| C.cmov r^{d}, r^{s1}, r^{s2} | 01101 | 100_0000_1000 | 0 | rrrrr | rrrrr | rrrrr |
| C.xchg r^{d}, r^{s} | 01101 | 110_0000_0000 | 0 | rrrrr | rrrrr | 00000 |
| C.nop k | 00000 | 000_0000_0000 | k | kkkkk | kkkkk | kkkkk |

Finally, there are four instructions that move data between the 32 general purpose registers and ‘system registers’, which are represented as 16-bit indices within the instructions. The C.mfspr r,s instruction reads from the system register with index s to general register r, while C.mtspr s,r writes to system register s from general register r. The C.xfspr r,s and C.xtspr s,r instructions are synonyms that swap contents of general register r and system register s.

| | 5 | 5 | 1 | 5 | 16 |
|---|---|---|---|---|---|
| C.mtspr s^{d}, r^{s} | 00111 | 10000 | 0 | rrrrr | ssss_ssss_ssss_ssss |
| C.mfspr r^{d}, s^{s} | 00111 | 10001 | 0 | rrrrr | ssss_ssss_ssss_ssss |
| C.xtspr s^{d}, r^{s} | 00111 | 10010 | 0 | rrrrr | ssss_ssss_ssss_ssss |
| C.xfspr r^{d}, s^{s} | 00111 | 10011 | 0 | rrrrr | ssss_ssss_ssss_ssss |

This CISC machine code language is deliberately minimal while being computationally complete. It contains nothing that is not mathematically proved to be safe with respect to cryptological security. All programs can be changed via the immediate constants in every arithmetic instruction to modify the plaintext value beneath the encryption in registers and memory at every point in the program, statistically independently over the complete range and with no statistical bias. That guarantees it is no less secure in a cryptological sense (‘semantic security’) than the encryption itself. In other words, encrypted computing with this CISC instruction set does not compromise encryption.

The dynamic translation unit (DTU) translates each 32-bit word of a CISC binary machine code instruction independently to a sequence of RISCV binary machine codes. Currently the longest single translation sequence is 43 long. The translation sequences are presented in a virtual program address space to the pipeline core of the KPU 3.0, which processes the RISCV machine code. The DTU is positioned between the fetch stage of the pipeline and the instruction memory manager unit (iMMU). The latter remaps addresses to actual physical locations in the RAM chips or other storage units. The following section describes the translations.

The translation of prefix words trivially takes each CISC C.prf k instruction word to the custom KPU RISCV instruction prfx k, where k is a 29-bit immediate constant. The RISCV instruction loads the accumulator register acc.

### Translation of CISC Arithmetic Instruction with One 128-Bit Immediate

Translation generally takes one CISC word to many more than one KPU RISCV word each. The simplest nontrivial case is that of the CISC C.add r,s,t,k′₁₁₋₀ word, which includes the final 12-bit portion k′₁₁₋₀ of a 128-bit encrypted constant. The prefixes that supplied the upper 116 bits will already have been translated to KPU RISCV prefixes that load the upper 116 bits of k′ into the accumulator register acc. The translation of the CISC C.add r,s,t,k′₁₁₋₀ word loads the 12-bit immediate into the accumulator register, decrypts the accumulated constant, then adds it together with register s and t into register r. (The translation of the rest of the program will be such that that unencrypted values reside in those registers at this point at runtime.)

Explicitly, the translation sequence first adds registers s and t into r, then loads the 12-bit rump of k′into acc and decrypts it into the private-to-translation register t1:

| | |
|---|---|
| prfx k′₁₂₇₋₉₉ | # previously translated prefix |
| prfx k′₉₈₋₇₀ | # previously translated prefix |
| prfx k′₆₉₋₄₁ | # previously translated prefix |
| prfx k′_{40- 12} | # previously translated prefix |
| addw r, s, t | # get register addition done |
| decr1i t1, acc, k′₁₁₋₀ | # load rump and start decryption |
| ... | |
| decrA t1, t1 | # finish decryption of k |
| addw r, r, t1 | # add k into r |

That translation has omitted a check with the encryption cache for the decryption before carrying out decryption. Including that gives the following translation of the CISC C.add r,s,t,k′₁₁₋₀ word:

| | |
|---|---|
| addw r, s, t | # get register addition done |
| getkdi t1, acc, k′₁₁₋₀ | # load rump and check cache |
| cskip sfr, 11 | # if decryption cached, skip decryption |
| decr1i t1, acc, k′₁₁₋₀ | # load rump and start decryption |
| ... | |
| decrA t1, t1 | # finish decryption of k |
| putkdi t1, acc, k′₁₁₋₀ | # cache any explicit decryption |
| addw r, r, t1 | # add k into r |

This sequence is 15 KPU RISCV words long.

The translation for the CISC C.sub r,s,t,k′₁₁₋₀ instruction word is the same but for the initial addw r,s,t in the translation above, which becomes subw r,s,t.

### Translation of CISC Arithmetic Instruction with Two 128-Bit Immediates

A CISC instruction that takes two immediate constants a and b is translated as follows. These include the unsigned comparator instructions, which add constants to both sides and set or unset the flag bit in the status register according to success or failure of the comparison. The immediates a′ and b′ will have been supplied via prefixes, all except for the last 12 bits of a′, which will be supplied in the last 32-bit word of the CISC instruction. That may be, for example, C.sfltu r,s,a′₁₁₋₀. All of the immediate, b′, is loaded into accumulator acd by the translated prefixes, and the upper 116 bits of a′, is loaded into the upper part of accumulator acc by them.

In the translation sequence for the final C.sfltu r,s,a′₁₁₋₀ word, first both those immediates a′, b′ are decrypted, then added to r and s respectively, then those results are compared:

| | |
|---|---|
| getkdi t1, acc, a′₁₁₋₀ | # decrypt a′ to a in t1 |
| cskip sfr, 11 | # . |
| decr1i t1, acc, a′₁₁₋₀ | # . |
| ... | |
| decrA t1, t1 | # . |
| putkdi t1, acc, a′₁₁₋₀ | # . |
| getkd t2, acd | # decrypt b′ to b in t2 |
| cskip sfr, 11 | # . |
| decr1 t2, acd | # . |
| ... | |
| decrA t2, t2 | # . |
| putkd t2, acd | # . |
| addw t1, r, t1 | # add a to r into t1 |
| addw t2, s, t2 | # add b to s into t2 |
| sltuw sfr, t1, t2 | # compare r+a with s+b |

This translation sequence is 29 KPU RISCV instructions long.

### Translation of CISC Arithmetic Instruction with Three 128-Bit Immediates

CISC arithmetic instructions such as multiplication take three 129-bit immediates, a′, b′ and c′. Those will be supplied via CISC prefix words that are translated to KPU RISCV prefix instruc-tions. The final word of the CISC instruction will be, for example C.mul r,s,t,a′₁₁₋₀, containing the last 12 bits of the immediate a′. The translation is a sequence of KPU RISCV instructions that decrypts the first two immediates a′ and b′ from the accumulator registers into which they have been loaded at this point and then adds them to the argument registers r and s, as in the case of the unsigned less-than comparator above. The third immediate, c′, is then decrypted and subtracted from the multiplication result. The translation is the same as that for C.sltu above, but instead of the final sfltu(sfr,t1,t2) word in the translation sequence, there is

| | |
|---|---|
| ... | |
| mulw t, r, s | # (was sltuw) |
| getkd t3, ace | # decrypt c′ to c in t3 |
| cskip sfr, 11 | # . |
| decr1 t3, ace | # . |
| ... | |
| decrA t3, t3 | # . |
| putkd t3, ace | # . |
| subw t, t, t3 | # subtract c from (r+a)*(s+b) |

That is a total of 43 RISCV instructions in the translation sequence for a last word C.mul t,r,s,a′₁₁₋₀ in the CISC multiplication instruction. However, if there are three encryption cache hits in that sequence at runtime, only 10 of those instructions will actually be executed.

### Translation of CISC Memory Access Instructions

The CISC load from memory instruction expects an unencrypted program address in register s and will decrypt the supplied immediate k′and add it to the content of s forming the address s+k, then encrypt s+k.

Earlier prefix words of the translation will have loaded the 116 high bits of k′into register acc, and what remains is to translate the CISC word C.ld r,k′₁₁₋₀[s]. At this point in the program at runtime, unencrypted values will reside in r and s. First the load and decryption of k′ to k is completed, then it is added to s to get s+k, and that is encrypted to a 128-bit address for memory. A call to the TLB with the custom KPU RISCV seta instruction replaces it with a 32-bit location, and that is used for the lookup in memory of the data, which has been stored encrypted and on retrieval must be decrypted into register r:

| | |
|---|---|
| getkdi t1, acc, k′₁₁₋₀ | # decrypt k′ to k in t1 ... |
| cskip sfr, 11 | # . |
| decr1i t1, acc, k′₁₁₋₀ | # . |
| ... | |
| decrA t1, t1 | # . |
| putkdi t1, acc, k′₁₁₋₀ | # . |
| addw t1, s, t1 | # sum k with s into t1 |
| getke t2, t1 | # encrypt sum into t2 ... |
| cskip sfr, 11 | # . |
| encr1 t2, t1 | # . |
| ... | |
| encrA t2, t1 | # . |
| putke t2, t1 | # . |
| seta t2 | # replace encrypted sum with 32b location |
| get t3, t2 | # read from memory at location |
| getkd r, t3 | # decrypt read value into r... |
| cskip sfr, 11 | # . |
| decr1 r, t3 | # . |
| ... | |
| decrA r, r | # . |
| putkd r, t3 | # . |

That is a length 42 RISCV instruction sequence, but with three cache hits at runtime only 9 of those instructions will be executed. Since program addresses are stored unencrypted not encrypted in memory, retrieving a program address as opposed to program data requires a translation sequence that misses out the final decryption stanza, for 31 instructions total. Storing data in memory requires a reversed sequence. Prefix words in the CISC instruction will have been translated first and at runtime at this point in the program will have loaded most of constant k′ into the accumulator register acc and the final CISC word to be translated is C.st [k′₁₁₋₀]r, s. The translation sequence at runtime may expect decrypted values in r and s, and it remains to complete k′ and decrypt it to k, add it to r and then encrypt r+k to get a 128-bit encrypted address. That 128-bit address must then be substituted via a call to the TLB with the KPU custom RISCV seta instruction by a 32-bit location in memory where the data in s will really be stored. The data must be encrypted before storage. The sequence of KPU RISCV instructions to do that is as follows:

| | |
|---|---|
| getkdi t1, acc, k′₁₁₋₀ | # decrypt k′ to k in t1 ... |
| cskip sfr, 11 | # . |
| decrli t1, acc, k₁₁₋₀ | # . |
| ... | |
| decrA t1, t1 | # . |
| putkdi t1, acc, k₁₁₋₀ | # . |
| addw t1, r, t1 | # sum k with s into t1 |
| getke t2, t1 | # encrypt sum into t2 ... |
| cskip sfr, 11 | # . |
| encr1 t2, t1 | # . |
| ... | |
| encrA t2, t2 | # . |
| seta t1 | # replace encrypted sum with 32b location |
| getke t3, s | # encrypt value to write into t3 ... |
| cskip sfr, 11 | # . |
| encr1 t3, s | # . |
| ... | |
| encrA t3, t3 | # . |
| putke t3, s | # . |
| put t1, t3 | # write encrypted value at location |

That sequence of KPU RISCV instructions is 42 long. To store a program address in memory, the stanza that encrypts the value to be written should be elided.

### Translation of CISC Call and Return from Subroutine

The single word CISC instruction C.jal b where b is the address of a subroutine is used to call the subroutine, placing the address a of the next CISC instruction in a return address register. Provided that return address a fits in 12 bits, the translation is the two RISCV instructions below. Here ill is a KPU translation-sequence-only register that no instruction reads and xer is a KPU translation-sequence-only register that no instruction writes, that maintains a zero value as its content. In a conventional RISC environment both can be replaced by the zer register, which always maintains a zero value inside, and is accessible to the programmer via the CISC instructions. But in the KPU environment any known value (zero, in this case) the encryption of which can be seen (by writing the register content to memory, for example) would make the encryption vulnerable to a known-text attack, so simpler translation is avoided here.

| | |
|---|---|
| addiw lnk, xer, a₁₁₋₀ | # store next address a in lnk |
| jalr ill, xer, b₁₁₋₀ | # jump to address b |

The addiw instruction is a simple way of transferring a short immediate to a target register. That writes into the Ink register the next address a in the virtual address space of the RISCV instructions and jumps to the address b in the real (CISC) address space. Real and virtual address spaces will resynchronize there. The Ink register is not accessible to the CISC programmer. It is one of the upper 32 of the 64 general purpose registers in the KPU, and those are available for RISCV instructions in the translation sequences alone.

If either address a, b does not fit in 12 bits, then translation uses prefixes, for example:

| | |
|---|---|
| prfx 0₈₋₀a₃₁₋₁₂ | |
| addiw lnk, acc, a₁₁₋₀ | # store next address a in lnk |
| prfx 0₈₋₀b₃₁₋₁₂ | |
| jalr ill, acc, b₁₁₋₀ | # jump to address b |

That is the case when both a,b are longer than 12 bits. If only one is, then only one extra prefix instruction is required, not two. Note that jalr r,s,k adds k to s before jumping to s+k, so jalr ill, acc, b₁₁₋₀ completes the installation of b into the accumulator register acc and then jumps to b.

The translation of the CISC single-word C.ret instruction is the single RISCV2 instruction

jalr ill, lnk, 0

which jumps to the return address previously stored in the Ink register by a call subroutine CISC instruction or restored to it after having been stored in memory. The ill register is never read by any instruction, so writing to it causes no data dependency delays.

### Translation of CISC Jump

The translation of a single-word CISC instruction C.j a that jumps to address a is a single RISCV instruction when address a fits in 12 bits. It is

jalr ill, xer, a₁₁₋₀ #jump to address a

and for a longer address a the translation is

| | |
|---|---|
| prfx 0₈₋₀a₃₁₋₁₂ | |
| jalr ill, acc, a₁₁₋₀ | # jump to address a |

The ill register is never read, so there are no pipeline dependency delays caused by writing to it.

### Translation of Miscellaneous CISC Register-Register Instructions

The single-word CISC conditional move instruction C.cmov r,s₁,s₂ translates to the single KPU RISCV instruction cmov r,s₁,s₂, since those CISC instructions that set the flag bit in the status register will have been translated to sequences that set the KPU sfr register, which is the one consulted by the KPU RISCV cmov instruction. The single-word CISC swap register instruction C.xchg r,s is translated to the short sequence

mov t, r

mov r, s

mov s, t

with a pipeline-private register t of choice as intermediate.

The single-word CISC no-op instruction C.nop k, where k is a short integer datum, translates to any preferred KPU RISCV instruction with null effect but which carries the datum as a label. A good choice is ori ill,xer,k as nothing will write to the xer register and nothing will read from the ill register, so there can be no pipeline data dependency to block its progress.

### Translation of CISC Instructions that Access System Registers

The single word C.mtspr s,r instruction is translated to the single KPU RISCV instruction mtspr s,r, possibly with a change to the 16-bit index s on a case-by-case basis. Similarly the single word C.mfspr r,s instruction is translated to the single KPU RISCV instruction mfspr r,s. The single word C.xtspr s,r instruction, which swaps contents between special register s and general register r, is translated to the short sequence:

mov t, r

mfspr r, s

mtspr s, t

where t is any temporary register. The C.xfspr r,s instruction is translated as C.xtspr s,r.

### Translation of CISC Instructions to Call and Return from System Functions

The single-word CISC instruction C.sys k is translated to the KPU RISCV instruction sequence addi s, xer, k; ecall r, s with appropriate registers r, s. The detail is implementation-dependent. The CISC C.rfe instruction that ends a software or hardware interrupt handler is translated to the KPU RISCV instruction sret.

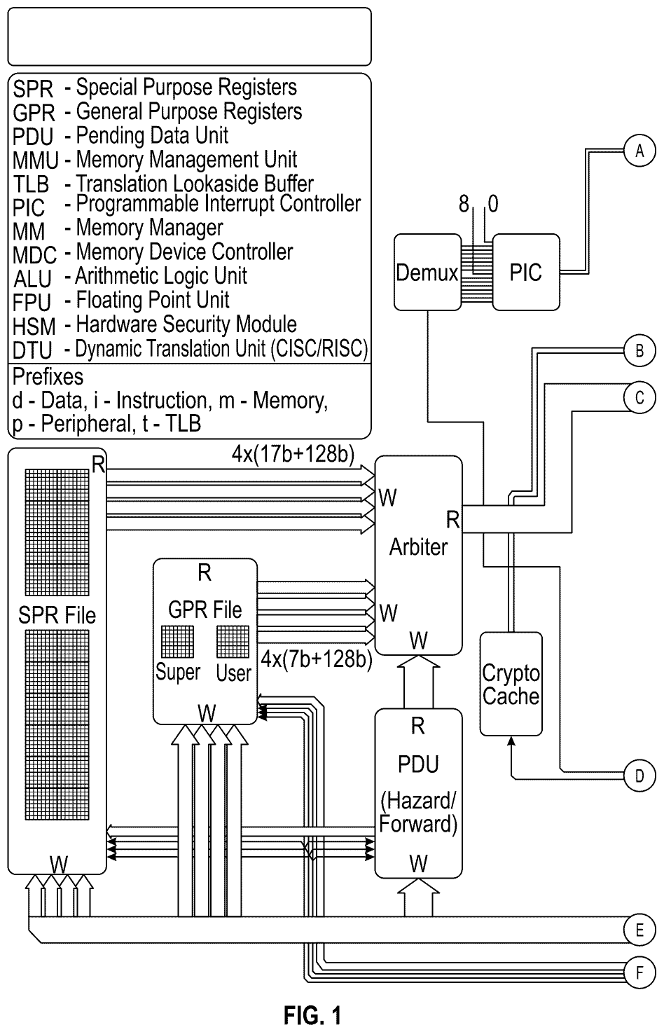

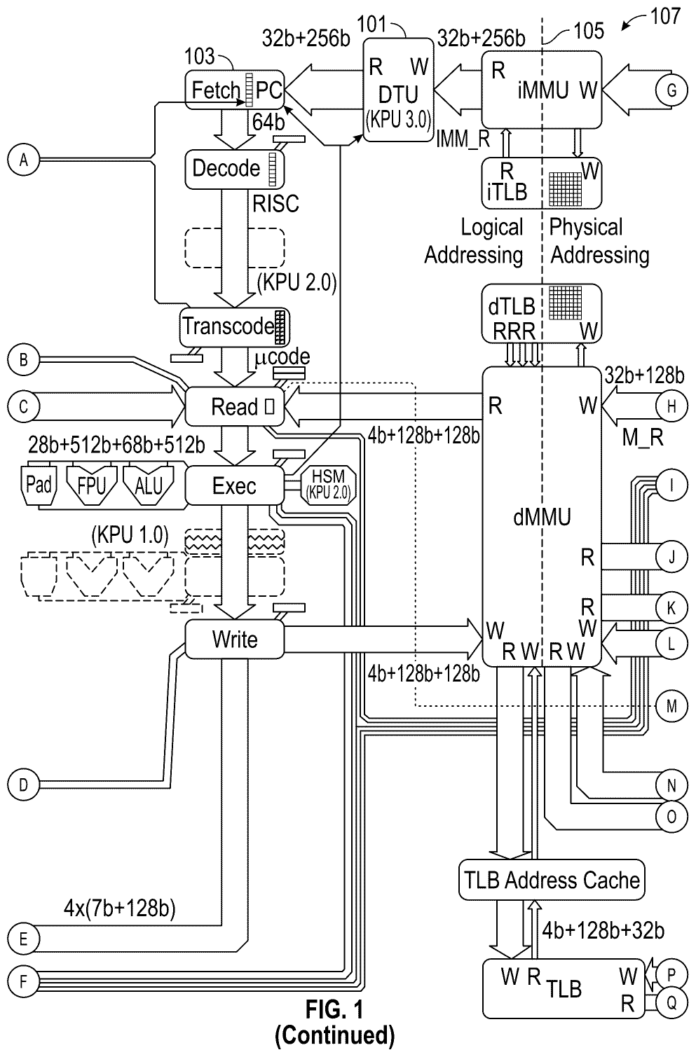

FIG. 1 illustrates a Dynamic Translation Unit (DTU) 101 positioned between the input to the pipeline's fetch stage 103 and the (instruction path) memory management unit (iMMU) 105 in the encrypted processor 107.

The iMMU 105 consists chiefly of an instruction address translation lookaside buffer (iTLB) whose job is to remap to physical memory the logical and perhaps per-process 0,4,8,12, . . . program addresses that appear in running programs. The translation is by ‘page’ of memory data, where a page is standardly 8 KB in size. The iTLB in the iMMU contains and manages that page database.

The DTU 101 is intended to fit between pipeline and iMMU in more or less any processor core (PC). DTU 101 enables programs in memory that are expressed in one machine code language (here the encrypted processor's CISC machine code language) to be seen as being expressed in another machine code language (here the encrypted processor's RISCV machine code language) for the processor core.

It should be appreciated that the data inputs for DTU 101 are binary words representing CISC instructions and its data outputs are binary words representing encrypted processor 107 RISCV instructions. DTU 101 is controlled by the processor core pipeline, which requests it for more binary RISCV instruction words, and it in turn emits control requests to the iMMU 105 for more binary CISC instruction words from memory.

Programs might be re-engineered from one machine code language to another via software but that cannot be done in the encrypted processor 107 because of the security considerations. The re-engineered program might have been modified at some stage by a ‘black hat’ attacker in order to reveal information at runtime that running in the encrypted processor 107 is intended to keep secure. For example, the attacker might excise the encryption sequences in the program for data that will be stored in memory.

### Overall Structure of DTU

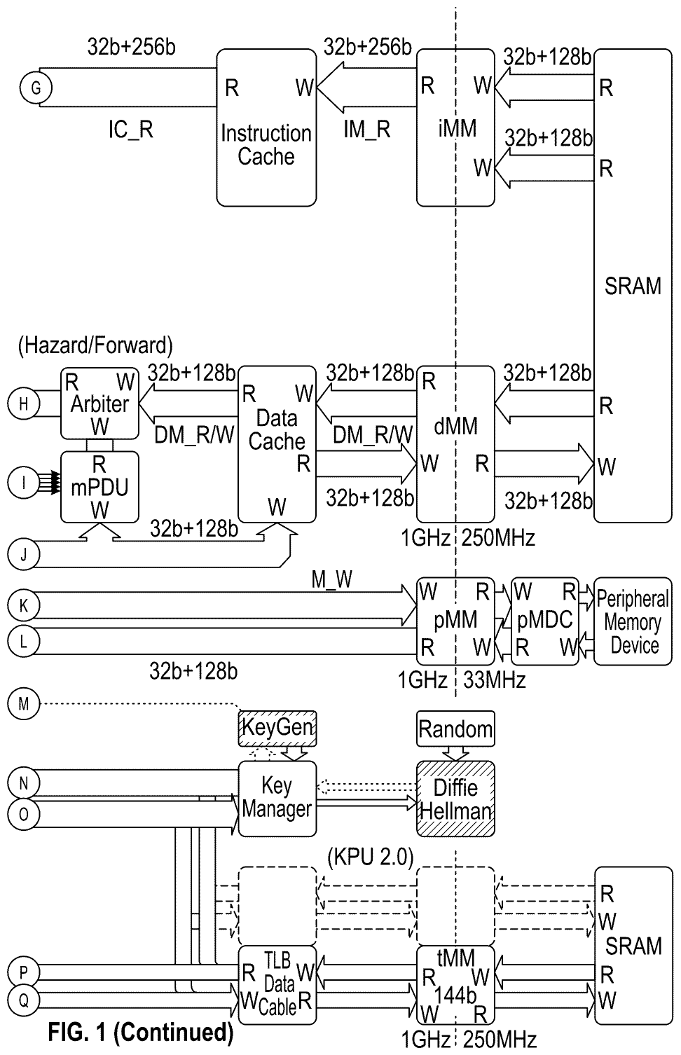

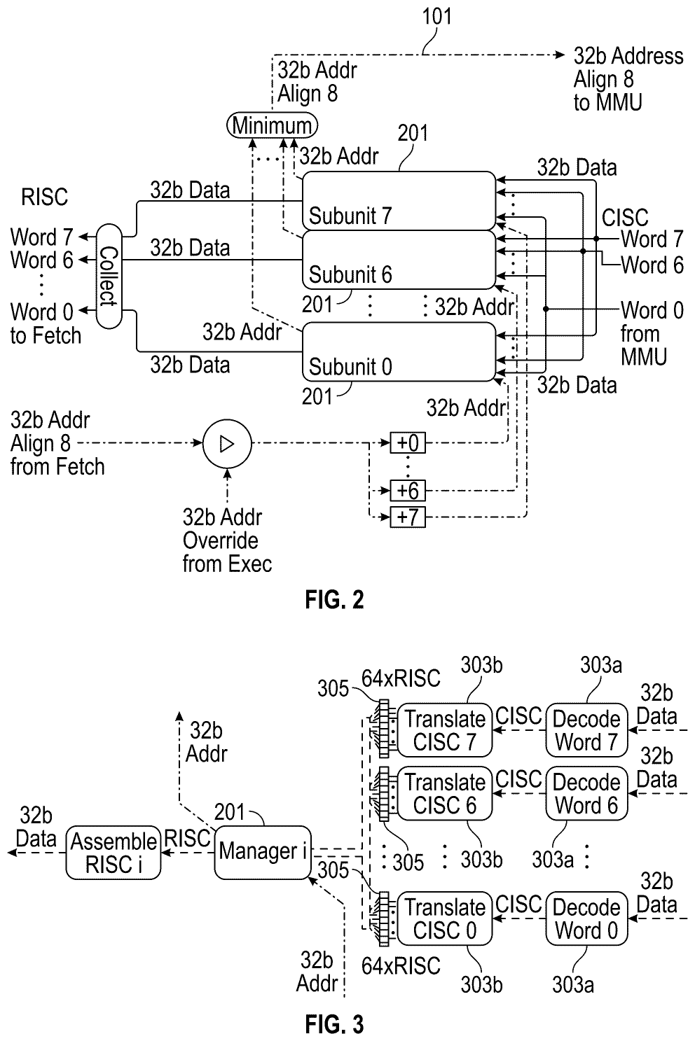

FIG. 2 illustrates further details of the dynamic translation unit in accordance with some embodiments. The DTU 101 consists of (8) repeated subunits 201 in parallel, each translating one of the (8) instruction words that the instruction path from the iMMU delivers simultaneously from memory. The number (8) can be varied to match the processor design. In the encrypted processor, the number (8) matches the width (8 words) of the instruction memory path. There are two data ports and two control ports in the DTU 101. Some (8) binary words representing CISC instructions enter the unit at most once per cycle at the input data port on the right of the subunits 201, and (8) binary words representing RISCV instructions leave the subunits 201 at most once per cycle via the data port at the left of the subunits 201.

The individual subunits 201 have four ports, two data ports and two control ports that take 32-bit addresses. On the input control port the address in the virtual address space of the wanted RISCV instruction binary word is asserted, and that appears on the output data port when the subunit has the data to construct it.

FIG. 3 illustrates further details of a subunit of the DTU in accordance with some embodiments. A vector of (8) CISC instruction words 301 enter on the input data port at right and are decoded 303a and translated 303b to up to 64 RISCV instructions each 305, which are stored in the subunit 201. Also stored are the ‘real’ addresses in memory of the original (8) CISC words and the ‘virtual’ addresses in the virtual address space of the RISCV instruction words. The latter calculation is described below.

Note that the input control port of the subunit 201 receives either a 32-bit virtual address of the next RISCV instruction wanted by the fetch stage of the processor pipeline, or a 32-bit real address in the CISC instruction address space generated by a jump or branch instruction in the exec stage of the processor pipeline. The two kinds are tagged distinctly. In the case of a 32-bit virtual address from the fetch stage, when it is received the subunit 201 invariantly already has data stored. It is not empty of data. That is because before the fetch stage emits a request for a ‘next’ program instruction it has first been set by a jump or branch (a reset is equivalent to a jump to program address 0) to a first program instruction and the handling of that jump/branch address in the subunit results in data being stored internally, described in (2) below. Continuing:
(1a) If the RISCV instruction that the input virtual address points to is among the data now held by the subunit 201 then it is assembled to a binary 32-bit word and produced on output.
(1b) If the required instruction is not among that data, then the subunit asks on its control port output for the next vector (of 8) CISC binary words from the iMMU contiguous with that which it stores. Addresses from fetch will increase monotonically absent a jump or branch instruction executing, as in (2).
(2) Receiving that next vector of (8) binary CISC instruction words and constructing and storing its translation to RISCV instructions, the subunit 201 constructs addresses for them by continuing on its count from the last it had before. The treatment is then as in (1a).

In the case of a 32-bit real jump or branch address control port input, the subunit is first reset to empty it of data. This is also the initial situation (which is equivalent to receipt of a jump address 0) at cycle 0.

The subunit 201 puts out on its output control port the address in the real CISC program address space of the aligned vector (of 8) CISC words that contain the target address. On receipt of that data, decode and translate happens and the subunit 201 constructs the virtual addresses of the RISCV instructions so the ith RISCV instruction translated for the CISC instruction at the jump/branch target address minus i words, where this is the ith subunit, gets a virtual address equal to the jump target address. That resynchronizes virtual and real address counts at this point. The RISCV binary instruction word at that point plus i words is then output on the data port.

It should be appreciated that storage of RISCV translation sequences as described in the paragraphs above duplicates hardware. The worst case has all subunits containing copies of the same data, the data having been created by identical hrdware logic applied to the same inputs to each.

In some embodiments storage and decode and translation logic is shared between subunits as far as possible. Sometimes the subunits necessarily do not all contain the same data. They may between them simultaneously contain data pertinent to 0, 1 or 2 consecutive vectors of (8) CISC instruction binary words. That means that exactly two sets of common storage and decode plus translation logic facilities must exist in order to cope with that. The two stores are filled independently and autonomously according to the following rules. Vectors of data received are sequences of contiguous binary instruction words and are designated by the address of their first element.
(a) if both are empty then any next vector of data received is placed in the lower store;
(b) if one of the two stores is full and one is empty then the lower is full and the upper empty:
   (b1) if the next vector of data received is contiguous to and following on from that in the lower store then it is placed in the upper store,
   (b2) if the next vector of data received is that already in the lower store then it overwrites the lower store (or is ignored, with the same effect),
   (b3) otherwise the next vector of data received is placed in the the lower store and the upper is vacated (this is the result of an early jump or branch instruction execution);
(c) if both stores are full then they contain contiguous vectors of data, and
   (c1) if the next vector of data received is contiguous with and following on from the data in the upper store then the upper store data replaces the data in the lower store (‘push down’) and the new vector of data replaces the data in the upper store,
   (c2) if the next vector of data received as already in either store then it replaces it (or is ignored, with same effect),
   (c3) otherwise the next vector of data received replaces the data in the lower store and the upper store is vacated (this is a branch/jump).

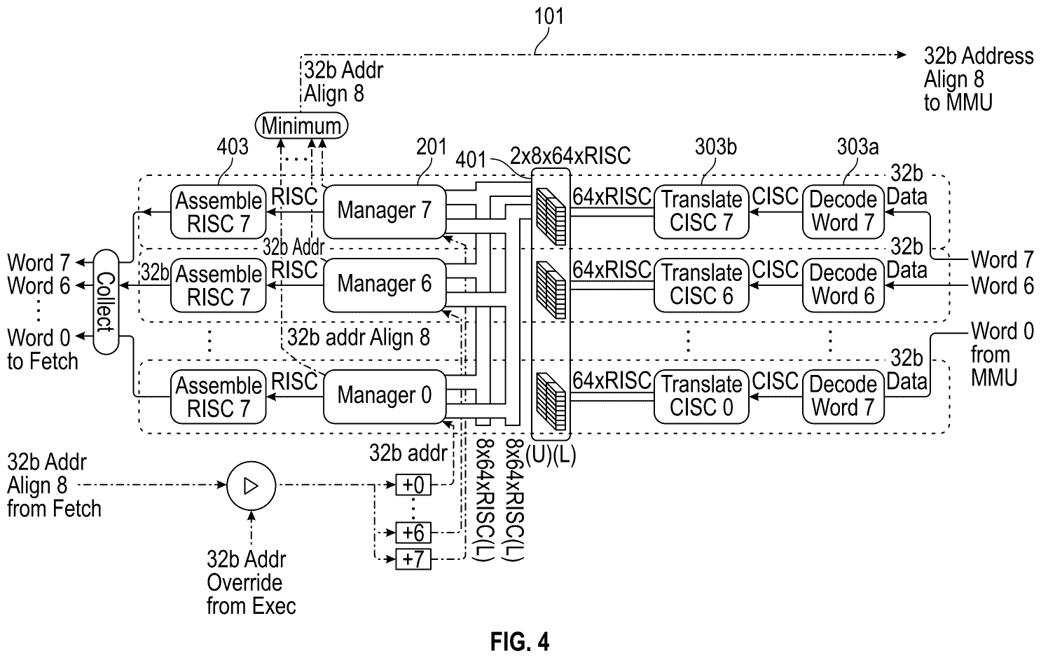

FIG. 4 illustrates a subunit sharing storage in accordance with some embodiments. The 8 translation subunits and 8 decode subunits lead to shared storage 401 for 2×8×64 RISCV instructions. The ‘2’ stands for the two stores of the above algorithm, the ‘8’ represents the size in binary instruction words of a single incoming vector of data, the ‘64’ represents the maximum length of a translation sequence of RISCV instruction words derived from any one incoming binary instruction word. Data is loaded independently and autonomously as described above, and is accessed by the 8 management subunits 201 which each pick out a single RISCV instruction to pass through a RISCV assembler unit 403, comprising one word (of 8) for output.

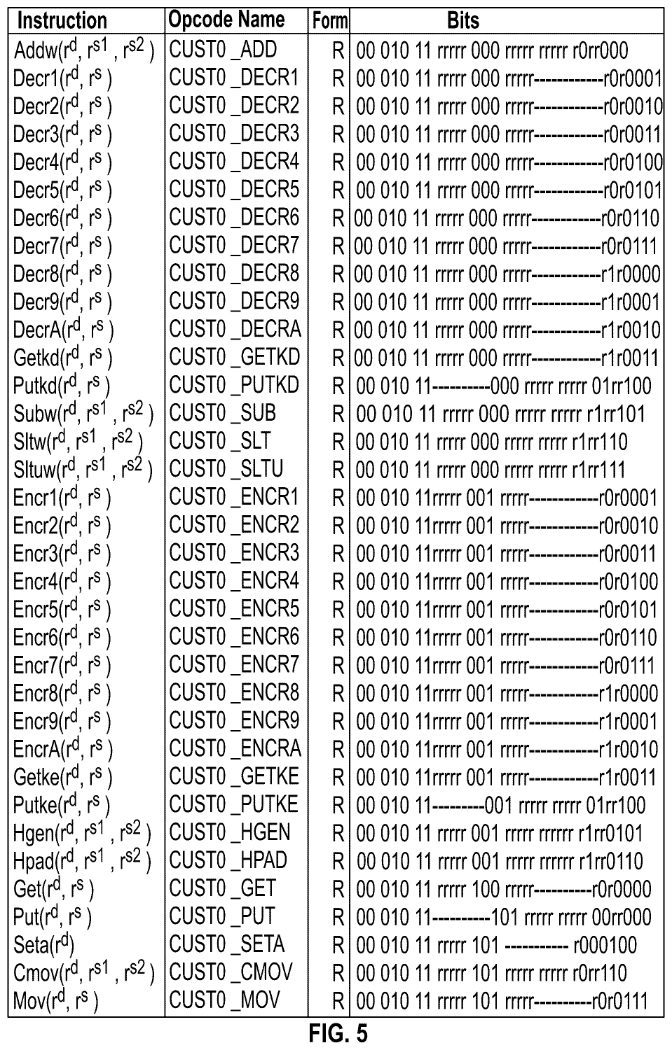

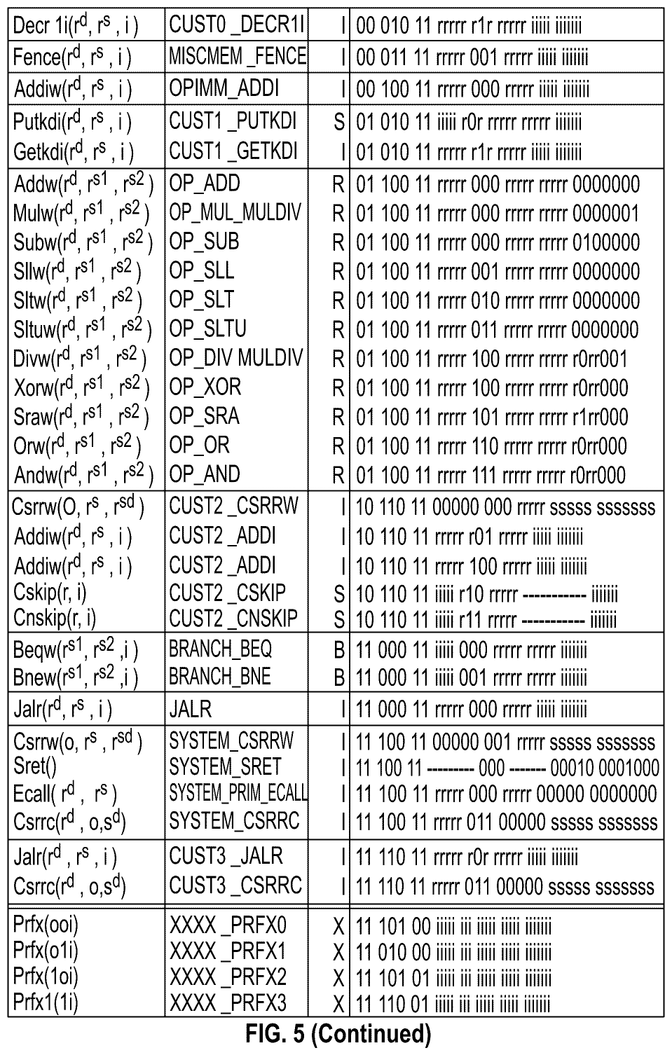

FIG. 5 provides a summary of the encrypted processor's RISCV instructions in accordance with some embodiments. In some embodiments Unrecognized words are converted to no-ops for security. Those are currently addiw(xer,xer,0) in-structions, but can be anything that does nothing and has no data dependency, such as mov(xer,xer).

In some embodiments, a method is provided. The method includes receiving first binary words associated with a first machine code language instruction set, e.g. CISC. As noted in the Figures above a plurality of subunits of a DTU disposed between a memory unit and a fetch stage of a pipeline of a processing core may receive the first binary words. The method includes. translating the first binary words to second binary words associated with a second machine code language, e.g., RISC, wherein the receiving and the translation are performed within a pipeline of a processor core of a processing device and wherein the first binary word and the second binary word are processed in encrypted format during the receiving and the translating. That is the data that is being processed is never decrypted to provide increased security over existing processing pipelines for processing data. In other words, the data being processed within the pipeline remains encrypted throughout processing within the pipeline. As noted above in FIG. 4, the subunits may share storage resources of the DTU in some embodiments.

1. A processor, comprising:
a dynamic translation unit (DTU) configured to receive first binary words associated with a first machine code language instruction set from a memory unit of the processor and translate the first binary words to second binary words associated with a second machine code language.

2. The processor of claim 1 wherein the DTU comprises a plurality of subunits arranged in parallel.

3. The processor of claim 1, wherein the DTU comprises two data ports and two control ports.

4. The processor of claim 1, wherein the binary words are encrypted during translation to the second machine code language.

5. The processor of claim 2, wherein the plurality of subunits share storage resources.

6. The processor of claim 1, wherein the DTU is contained within a pipeline of a processing core of the processor.

7. The processor of claim 1, wherein the first machine code language is Complex Instruction Set Computer (CISC) and the second machine code is Reduced Instruction Set Computer (RISC).

8. A method, comprising:
receiving first binary words associated with a first machine code language instruction set; and
translating the first binary words to second binary words associated with a second machine code language, wherein the receiving and the translation are performed within a pipeline of a processor core and wherein the first binary word and the second binary word are processed in encrypted format during the receiving and the translating.

9. The method of claim 8, wherein the first machine code language is Complex Instruction Set Computer (CISC) and the second machine code is Reduced Instruction Set Computer (RISC).

10. The method of claim 8, wherein the receiving is performed by a dynamic translation unit disposed between a memory unit of the pipeline and a fetch stage of the pipeline.

11. The method of claim 8, wherein data within the pipeline remains encrypted throughout processing within the pipeline.

12. The method of claim 8, further comprising:
sharing storage resources when translating the first binary words.

13. The method of claim 8 wherein each of the first binary words are received into a corresponding subunit of a translation unit.

14. The method of claim 8 wherein a maximum of 8 binary words are received per cycle.

15. A non-transitory computer readable storage medium storing instructions, which when executed, cause a processing device to:
receive first binary words associated with a first machine code language instruction set; and
translate the first binary words to second binary words associated with a second machine code language, wherein the receiving and the translation are performed within a pipeline of a processor core and wherein the first binary word and the second binary word are processed in encrypted format during the receiving and the translating.

16. The computer readable medium of claim 15 wherein the first machine code language is Complex Instruction Set Computer (CISC) and the second machine code is Reduced Instruction Set Computer (RISC).

17. The computer readable medium of claim 15 wherein the receiving is performed by a dynamic translation unit disposed between a memory unit of the pipeline and a fetch stage of the pipeline.

18. The computer readable medium of claim 15 wherein data within the pipeline remains encrypted throughout processing within the pipeline.

19. The computer readable medium of claim 15 wherein a maximum of 8 binary words are received per cycle.

20. The computer readable medium of claim 15 wherein the processing device is further configured to share storage resources when translating the first binary words.
